(19) United States
(12) Patent Application Publication
(10) Pub. No.: US 2024/0028955 A1
(43) Pub. Date: Jan. 25, 2024

(54) METHODS AND SYSTEMS FOR USING MACHINE LEARNING WITH INFERENCE MODELS TO RESOLVE PERFORMANCE PROBLEMS WITH OBJECTS OF A DATA CENTER

(71) Applicant: VMware, Inc., Palo Alto, CA (US)

(72) Inventors: Ashot Nshan Harutyunyan, Yerevan (AM); Arnak Poghosyan, Yerevan (AM); Lilit Harutyunyan, Yerevan (AM); Nelli Aghajanyan, Yerevan (AM); Tigran Bunarjyan, Yerevan (AM); Marine Harutyunyan, Yerevan (AM); Sam Israelyan, Yerevan (AM)

(73) Assignee: VMware, Inc., Palo Alto, CA (US)

(21) Appl. No.: 18/100,159

(22) Filed: Jan. 23, 2023

Related U.S. Application Data
(63) Continuation-in-part of application No. 17/871,080, filed on Jul. 22, 2022.

(51) Int. Cl. G06N 20/00; G06N 5/04

(52) U.S. Cl. CPC G06N 20/00; G06N 5/04

(57) ABSTRACT

Automated, computer-implemented methods and systems describe herein resolve performance problems with objects executing in a data center. The operations manager uses machine learning to train an inference model that relates probability distributions of event types of log messages of the object to a key performance indicator (“KPI”) of the object. The operations manager monitors the KPI for run-time KPI values that violates a KPI threshold. When the KPI violates the threshold, the operations manager determines probabilities of event types of log messages recorded in a run-time interval and uses the inference model to determine event types of the probabilities of event types of log messages in the run-time interval to determine a root cause of the performance problem. The inference models can be used to identify log messages of event types that correspond to potential performance problems with data center objects and execute appropriate remedial measures to avoid the problems.

### CROSS-REFERENCE TO RELATED APPLICATION

This application is a continuation-in-part to application Ser. No. 17/871,080, filed Jul. 22, 2022.

### TECHNICAL FIELD

This disclosure is directed to resolving performance problems with objects executing in a data center, and in particular, to using machine learning to identify and resolve root causes of performance problems.

### BACKGROUND

Electronic computing has evolved from primitive, vacuum-tube-based computer systems, initially developed during the 1940s, to modern electronic computing systems in which large numbers of multi-processor computer systems, such as server computers and workstations, are networked together with large-capacity data-storage devices to produce geographically distributed computing systems that provide enormous computational bandwidths and data-storage capacities. These large, distributed computing systems include data centers and are made possible by advancements in virtualization, computer networking, distributed operating systems and applications, data-storage appliances, computer hardware, and software technologies. The number and size of data centers has grown in recent years to meet the increasing demand for information technology (“IT”) services, such as running applications for organizations that provide business services, web services, online retail services, streaming services, and other cloud services to millions of users each day.

Advancements in virtualization and software technologies provide many advantages for development and execution of distributed applications of businesses, governments, and other organizations as tenants in data centers. A distributed application comprises multiple software components called “microservices” that are executed in virtual machines (“VMs”) or in containers on multiple server computers of a data center. The microservices communicate and coordinate data processing and data stores to appear as a single coherent application that provides services to end users. Data centers run tens of thousands of distributed applications with microservices that can be scaled up or down to meet customer and client demands. For example, VMs that run microservices can be created to satisfy increasing demand for the microservices or deleted when demand for the microservices decreases, which frees up computing resources. VMs and containers can also be migrated to different host server computers within a data center to optimize use of resources.

Data center management tools have been developed to monitor the performance of applications executing in a data center. Management tools collect metrics, such as CPU usage, memory usage, disk space available, and network throughput of applications. Data center tenants and system administrators rely on key performance indicators (“KPIs”) to monitor the overall health and performance of applications executing in a data center. A KPI can be constructed from one or more metrics. KPIs that do not depend on metrics can also be used to monitor performance of applications. For example, a KPI for an online shopping application could be the number of shopping carts successfully closed per unit time. A KPI for a website may be response times to user requests. Other KPIs can be used to monitor performance of various services provided by different microservices of a distributed application. Consider, for example, a distributed application that pro-v banking services via a bank website or a mobile application (“mobile app”). One microservice provides front-end services that enable users to input banking requests and receive responses to requests via the website or the mobile app. Other microservices of the distributed application provide back-end services that are executed in VMs or containers running on hosts of the data center. These services include processing user banking requests, maintaining data storage, and retrieving user information from data storage. Each of these microservices can be monitored with an error rate KPI and a time span KPI.

Although KPIs are useful for monitoring the health and performance of applications, KPIs are typically not helpful in revealing the root causes of health issues or performance problems. For example, a sudden increase in a response time KPI is useful in revealing a problem that users are experiencing, but the KPI does not reveal the root cause of the increase in response times. The increase may be due to any number of issues. For example, the microservices may be running in separate VMS that are contending for CPU time or for available memory of a host. A central microservice of the application may have stopped responding to requests from other microservices because the host the runs the central microservice is experiencing performance issues.

Because management tools cannot identify the root cause of most problems occurring in a data center, the search for root causes of performance problems is typically performed by Learns of software engineers. Each team searches for a root cause of a problem by manually searching for issues in metrics and log messages. However, the troubleshooting process can take days and weeks, and in some cases longer. Data center tenants cannot afford such long periods of time spent sifting through various metrics, log messages, and lines of code for a root cause of a problem. Employing teams of engineers to spend days and weeks to search for a problem is expensive and error prone. Problems with a data center tenant's applications result in downtime and continue to the slow performance of their applications, which frustrates users, damages a brand name, causes lost revenue, and in many cases can deny people access to vital services provided by data center tenants. Systems administrators and data center tenants seek automated methods and systems that identify root causes of run-time problems and significantly reduce, or eliminate entirely reliance on teams of engineers to identify the root causes of performance issues.

### SUMMARY

This disclosure is directed to automated, computer-implemented methods and systems for resolving performance problems with objects executing in a data center. The automated methods are executed by an operations manager that runs in a host of the data center. The operations manager collects log messages from event sources associated with a data center object. Each log message is an unstructured or semi-structured time-stamped message that records an event that occurred during execution of the object, execution of an operating system, execution of a service provided by the object, or an issue occurring with the object. The log messages are stored in log files. The operations manager uses machine learning to train an inference model that relates probability distributions of event types of log messages of the object to a key performance indicator (“KPI”) of the object over. The operations manager monitors the KPI for run-time KPI values that violates a KPI threshold. When the KPI violates the threshold, the operations manager determines probabilities of event types of log messages recorded in a run-time interval and uses the inference model to determine event types of the probabilities of event types of log messages in the run-time interval to determine a root cause of the performance problem. The operations manager executes one or more remedial measures that resolve the root cause of the performance problem. The one or more remedial measures include restarting a host of the object, restarting the object, deleting the object, and migrating the object to a different host. In other implementations, an inference model is trained to identify log messages of event types to impact performance of data center objects. One or more remedial measures are executed to optimize planning and avoid performance problems with the objects.

### DESCRIPTION OF THE DRAWINGS

FIG. 1 shows an example of a virtualization layer located above a physical data center.

FIGS. 2A-2B shows an operations manager that receives object information from various physical and virtual objects.

FIG. 3 shows an example architecture of an operations manager.

FIG. 4 shows an example of logging log messages in log files.

FIG. 5 shows an example source code of an event source.

FIG. 6 shows an example of a log write instruction.

FIG. 7 shows an example of a log message generated by the log write instruction in FIG. 6.

FIG. 8 shows a small, eight-entry portion of a log file.

FIG. 9A shown a table of examples of regular expressions designed to match particular character strings of log messages.

FIG. 9B shows a table of examples primary Grok patterns and corresponding regular expressions.

FIG. 9C shows an example of a Grok expression used to extract tokens from a log message.

FIG. 10 shows an example plot of a key performance indicator (“KPI”) associated with an object of a data center.

FIG. 11 shows construction of probability distributions.

FIG. 12 shows an example data frame of probability distributions and KPI labels.

FIG. 13 shows matrix representations of a parametric model.

FIG. 14A shows an example of the data frame partitioned into training set and a validation set.

FIGS. 14B-14E show an example of training a parametric model using the backward stepwise process described above.

FIGS. 15A-15E show of an example of k-fold cross validation applied to an example set of metrics.

FIGS. 16A-16E show an example of determining a K-nearest neighbor regression model.

FIG. 17 shows an example graphical user interface that displays the event types and corresponding most recently generated log messages.

FIG. 18 shows an example graphical user interface that displays KPIs associated with different applications running in a distributed computing system.

FIGS. 19A-19B show examples of highest ranked event types associated with different types of performance problems.

FIG. 20 shows an example of highest ranked run-time event types.

FIG. 21 shows a table of example rules stored in a data storage device.

FIG. 22A shows an example graphical user interface that displays a list of objects executing in a data center.

FIG. 22B shows a remedial measures pane of a graphical user interface.

FIG. 23 shows an example architecture of a computer system that performs automated processes for resolving performance problems with objects executing in a data center.

FIG. 24 is a flow diagram illustrating an example implementation of a method for resolving a root cause of a performance problem with an object executing in a data center.

FIG. 25 is a flow diagram illustrating an example implementation of the “use machine learning to train an inference model that relates probability distributions of event types of log messages of the object to a KPI of the object” procedure performed in FIG. 24.

FIG. 26 is a flow diagram illustrating an example implementation of the “determine probabilities of event types of log messages generated in the run-time interval” procedure performed in FIG. 24.

FIG. 27 is a flow diagram illustrating an example implementation of the “use the inference model to determine log messages in the run-time interval that describe the root cause of the performance problem” procedure performed in FIG. 24.

FIG. 28 is a flow diagram illustrating an example implementation of a method for avoiding performance problems with an object executing in a data center.

### DETAILED DESCRIPTION

This disclosure presents automated methods and systems for resolving performance problems with applications executing in a data center object. Log messages, event types, and key performance indicators are described in a first subsection. Automated methods and systems for resolving performance problems with applications executing in a data center are described in a second subsection.

### Log Messages, Event types, and Key Performance Indicators

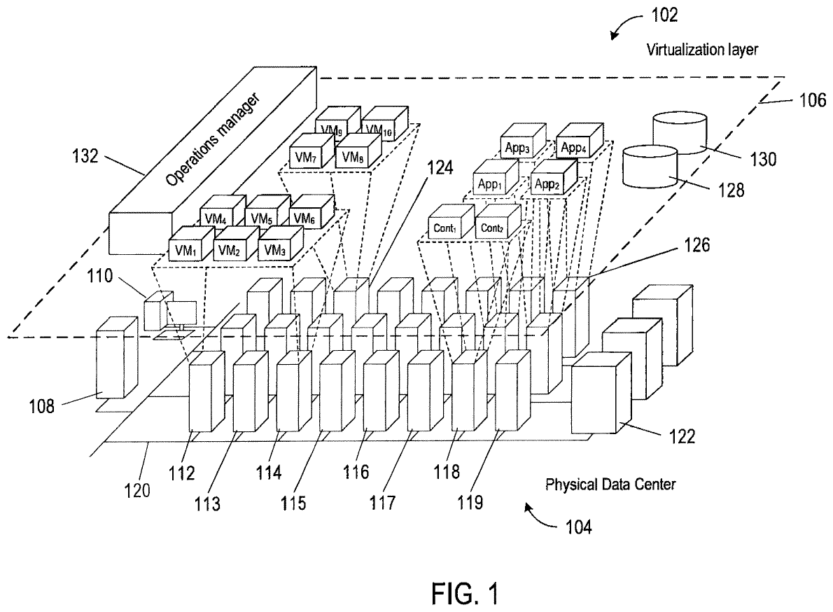

FIG. 1 shows an example of a virtualization layer 102 located above a physical data center 104. For the sake of illustration, the virtualization layer 102 is separated from the physical data center 104 by a virtual-interface plane 106. The physical data center 104 is an example of a distributed computing system. The physical data center 104 comprises physical objects, including an administration computer system 108, any of various computers, such as PC 110, on which an operations management interface may be displayed in a graphical user interface to system administrators and other users, server computers, such as server computers 112-119, data-storage devices, and network devices. The server computers may be networked together to form server-computer groups within the data center 104. The example physical data center 104 includes three server-computer groups each of which have eight server computers. For example, server-computer group 120 comprises interconnected server computers 112-119 that are connected to a mass-storage array 122. Within each server-computer group, certain server computers are grouped together to form a cluster that provides an aggregate set of resources (i.e., resource pool) to objects in the virtualization layer 102. Different physical data centers may include many different types of computers, networks, data-storage systems, and devices connected according to many different types of connection topologies.

The virtualization layer 102 includes virtual objects, such as virtual machines (“VMs”), applications, and containers, hosted by the server computers in the physical data center 104. A VM is a compute resource that uses software instead of a physical computer to run programs and deploy applications. One or more VMs run on a physical “host” server computer. Each VM runs its own operating system called a “guest operating system” and functions separately from the other VMs, even though the VMs may all be running on the same host. A container contains a single program or application along with dependencies and libraries and containers share the same operating system. Multiple containers can be run in pods on the same server computers. The virtualization layer 102 may also include a virtual network (not illustrated) of virtual switches, routers, load balancers formed from the physical switches, routers, and NICs of the physical data center 104. Certain server computers host VMs while other host containers. For example, server computer 118 hosts two containers identified as Cont₁ and Cont₂; cluster of server computers 112-114 host six VMs identified as VM₁, VM₂, VM₃, VM₄, VM₅, and VM₆; server computer 124 hosts four VMs identified as VM₇, VM₈, VM₉, VM₁₀. Other server computers may host applications. For example, server computer 126 hosts applications identified as App₁, App₂, App₃, and App₄. The virtual-interface plane 106 abstracts the resources of the physical data center 104 to one or more VDCs comprising the virtual objects and one or more virtual data stores, such as virtual data stores 128 and 130. For example, one VDC may comprise VM₇, VM₈, VM₉, and VM₁₀ running on server computer 124 and virtual data store 128.

Automated methods described below are performed by an operations manager 132 that is executed in one or more VMs or containers on the administration computer system 108. The operations manager 132 is an automated computer implemented tool that aids IT administrators with monitoring, troubleshooting, and managing the health and capacity of the data center virtual environment. The operations manager 132 provides management across physical, virtual, and cloud environments. The operations manager 132 receives object information, which includes streams of metric data and log messages from various physical and virtual objects of the data center described below.

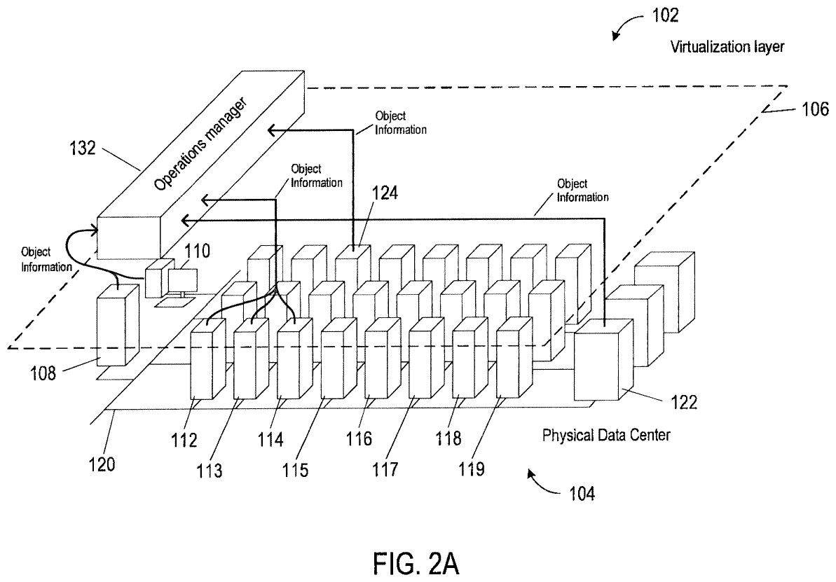

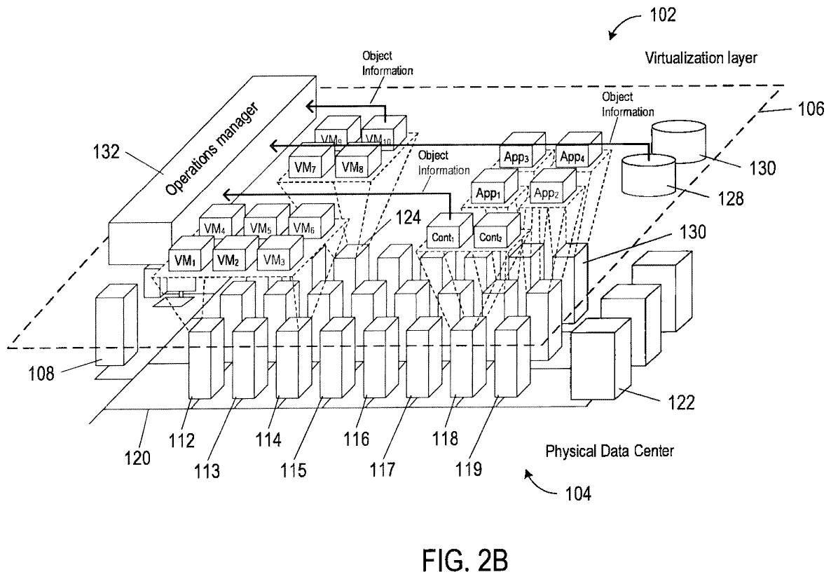

FIGS. 2A-2B show examples of the operations manager 132 receiving object information from various physical and virtual objects. Directional arrows represent object information sent from physical and virtual resources to the management server 132. In FIG. 2A, the operating systems of PC 110, server computers 108 and 124, and mass-storage array 122 send object information to the operations manager 132. A cluster of server computers 112-114 send object information to the operations manager 132. In FIG. 2B, the VMs, containers, applications, and virtual storage independently send object information to the operations manager 132. Certain objects may send metrics as the object information is generated while other objects may only send object information at certain times or when requested to send object information by the operations manager 132. The operations manager 132 collects and processes the object information as described below to detect performance problems and generate recommendations to correct the performance problems and executes user-selected remedial to correct problem. Depending on the type of the performance problem, recommendations include reconfiguring a virtual network of a VDC or migrating VMs from one server computer to another, powering down server computers, replacing VMs disabled by physical hardware problems and failures, spinning up cloned VMs on additional server computers to ensure that services provided by the VMs are accessible to increasing demand or when one of the VMs becomes compute or data-access bound.

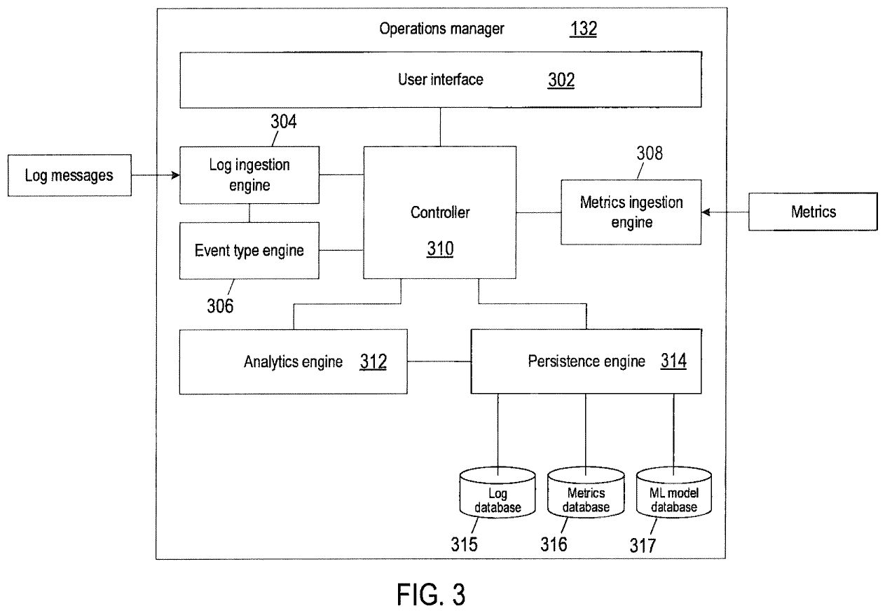

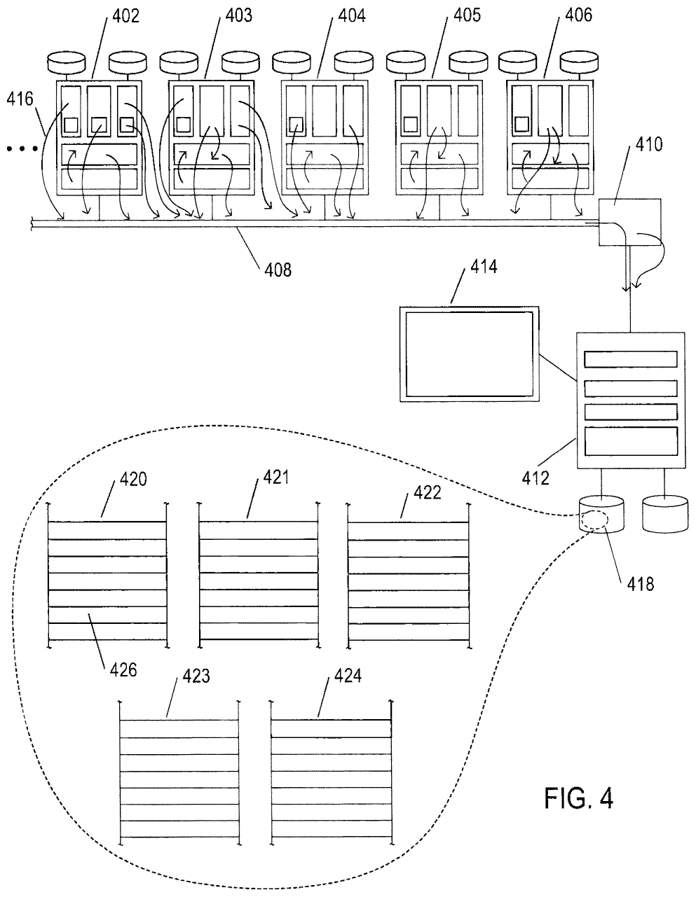

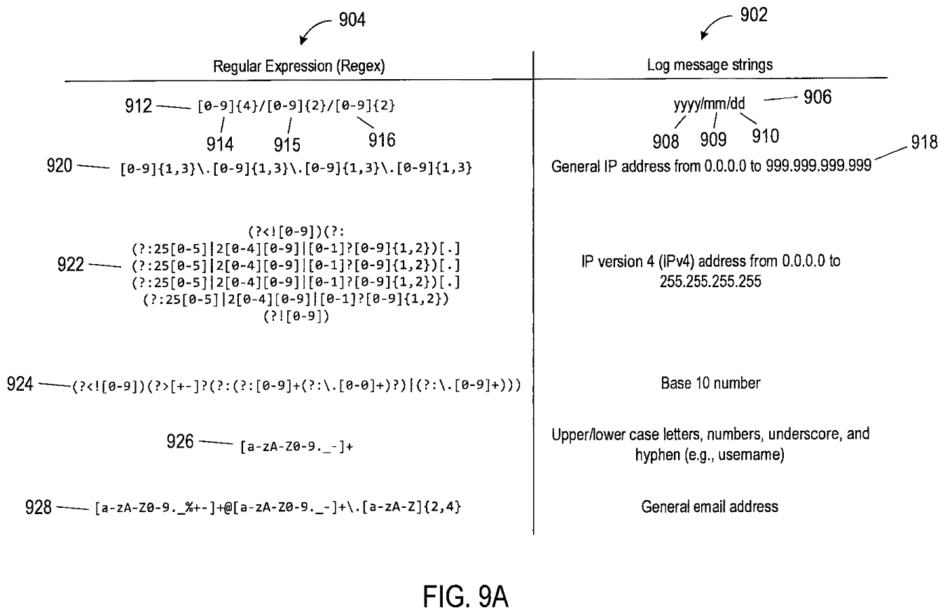

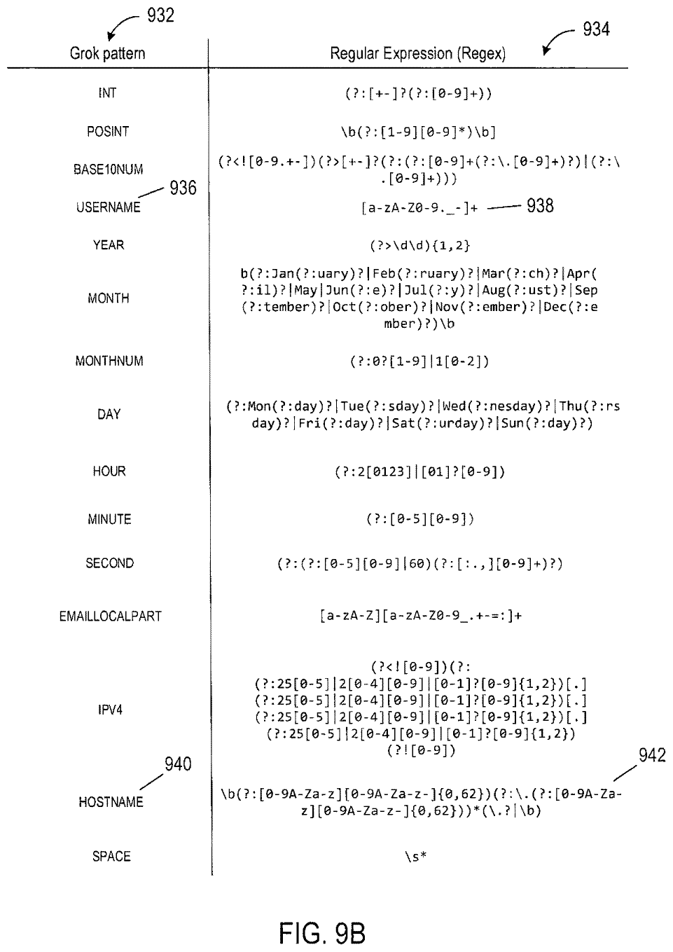

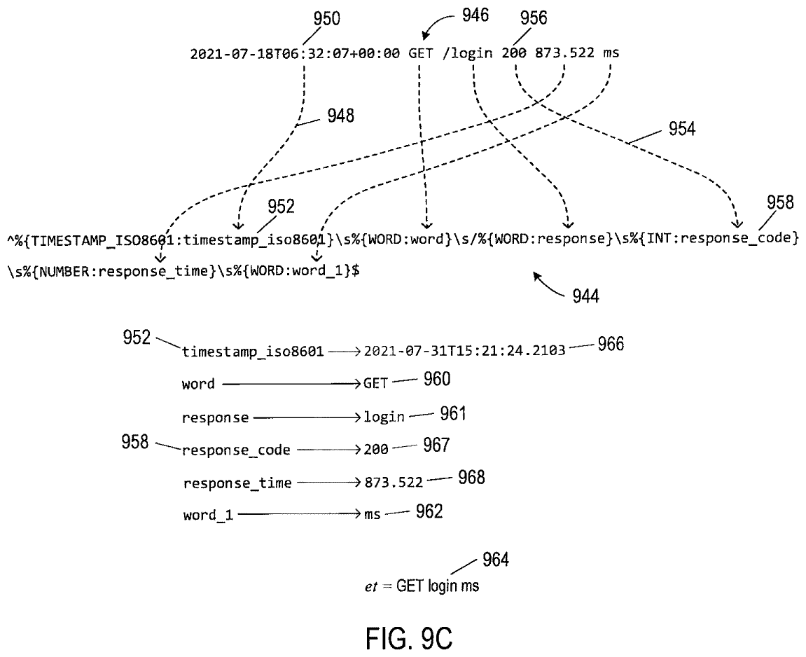

FIG. 3 shows an example architecture of the operations manager 132. This example architecture includes a user interface 302 that provides graphical user interfaces for data center management, system administrators, and application owners to receive alerts, view metrics, log messages, and KPIs, and execute user-selected remedial measures to correct performance problems. The operations manager 132 includes a log ingestion engine 304 that receives log messages sent from log monitoring agents deployed at sources of log messages described below with reference to FIGS. 4-8, and an event type engine 306 that extracts event types from the log messages, as described below with reference to FIGS. 9A-9C. The operations manager 132 includes a metrics ingestion engine 308 that receives metrics from agents deployed at sources of metric data. The operations manager 132 includes a controller 310 that manages and directs the flow of object information collected by the engines 304 and 308. The controller 310 manages the user interface 302 and directs the flow of instructions received via the user interface 302 and the flow of information displayed on the user interface 302. The controller 310 directs the flow of object information to the analytics engine 312. The analytics engine 312 performs system health assessments by monitoring key performance indicators (“KPIs”) for problems with applications or other data center objects, maintains dynamic thresholds of metrics, and generates alerts in response to KPIs that violate corresponding thresholds. The analytics engine 312 uses machine learning (“ML”) as described below to generate models that are used to generate rules for interpreting degradation of a KPI or indicate the most influential dimensions/features for a long-term explanation of those degradations. The persistence engine 314 stores metrics, log messages, and the models in corresponding data bases 315-317.

### Log Messages

FIG. 4 shows an example of logging log messages in log files. In FIG. 4, computer systems 402-406 within a data center are linked together by an electronic communications medium 408 and additionally linked through a communications bridge/router 410 to an administration computer system 412 that includes an administrative console 414. Each of the computer systems 402-406 may run a log monitoring agent that forwards log messages to the operations manager 132 executing on the administration computer system 412. As indicated by curved arrows, such as curved arrow 416, multiple components within each of the computer systems 402-406 as well as the communications bridge/router 410 generate log messages that are forwarded to the administration computer system 412. Each log message records an event and is generated by any event source. Event sources may be, but are not limited to, programs, operating systems, VMs, guest operating systems, containers, network devices, machine codes, event channels, and other computer programs or processes running on the computer systems 402-406, the bridge router 410 and any other components of a data center. Log messages are received by log monitoring agents at various hierarchical levels within a computer system and then forwarded to the administration computer system 412. The operations manager 132 records the log messages in log files 420-424 of the log database 315 of a data-storage device or appliance 418. Rectangles, such as rectangle 426, represent individual log messages. For example, log file 420 may contain a list of log messages generated within the computer system 402. Each log monitoring agent has a configuration that includes a log path and a log parser. The log path specifies a unique file system path in terms of a directory tree hierarchy that identifies the storage location of a log file on the data-storage device 418. The log monitoring agent receives specific file and event channel log paths to monitor log files and the log parser includes log parsing rules to extract and format lines of the log message into log message fields described below.

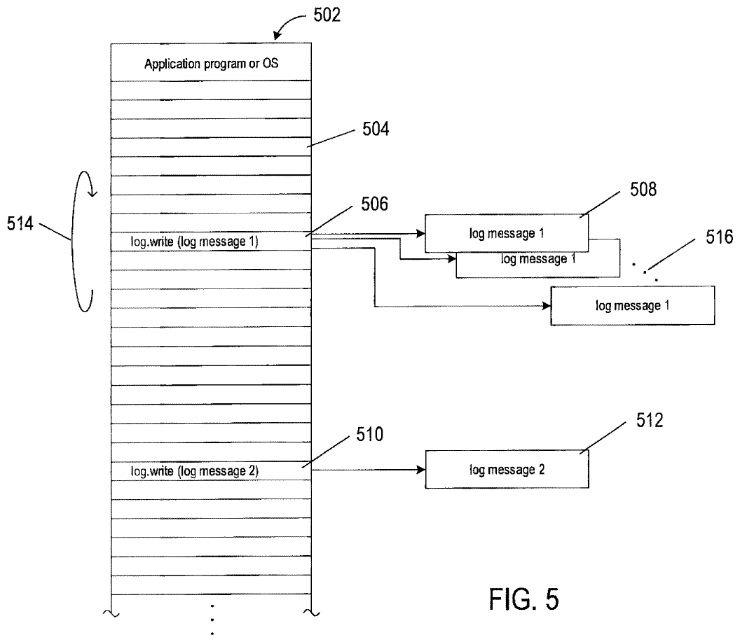

FIG. 5 shows an example source code 502 of an event source. The event source can be an application, an operating system, a VM, a guest operating system, or any other computer program or machine code that generates log messages. The source code 502 is just one example of an event source that generates log messages. Rectangles, such as rectangle 504, represent a definition, a comment, a statement, or a computer instruction that expresses some action to be executed by a computer. The source code 502 includes log write instructions that generate log messages when certain events predetermined by a developer occur during execution of the source code 502. For example, source code 502 includes an example log write instruction 506 that when executed generates a “log message 1” represented by rectangle 508, and a second example log write instruction 510 that when executed generates “log message 2” represented by rectangle 512. In the example of FIG. 5, the log write instruction 508 is embedded within a set of computer instructions that are repeatedly executed in a loop 514. As shown in FIG. 5, the same log message 1 is repeatedly generated 516. The same type of log write instructions may also be located in different places throughout the source code, which in turns creates repeats of essentially the same type of log message in the log file.

In FIG. 5, the notation “log.write( )” is a general representation of a log write instruction. In practice, the form of the log write instruction varies for different programming languages. In general, the log write instructions are determined by the developer and are unstructured, or semi-structured, and in many cases are relatively cryptic. For example, log write instructions may include instructions for time stamping the log message and contain a message comprising natural-language words and/or phrases as well as various types of text strings that represent file names, path names, and perhaps various alphanumeric parameters that may identify objects, such as VMs, containers, or virtual network interfaces. In practice, a log write instruction may also include the name of the source of the log message (e.g., name of the application program, operating system and version, server computer, and network device) and may include the name of the log file to which the log message is recorded. Log write instructions are written in a source code by the developer of a program or operating system in order to record events that occur while an operating system or application program is executing. For example, a developer may include log write instructions that record informative events including, but are not limited to, identifying startups, shutdowns, I/O operations of applications or devices; errors identifying runtime deviations from normal behavior or unexpected conditions of applications or non-responsive devices; fatal events identifying severe conditions that cause premature termination; and warnings that indicate undesirable or unexpected behaviors that do not rise to the level of errors or fatal events. Problem-related log messages (i.e., log messages indicative of a problem) can be warning log messages, error log messages, and fatal log messages. Informative log messages are indicative of a normal or benign state of an event source.

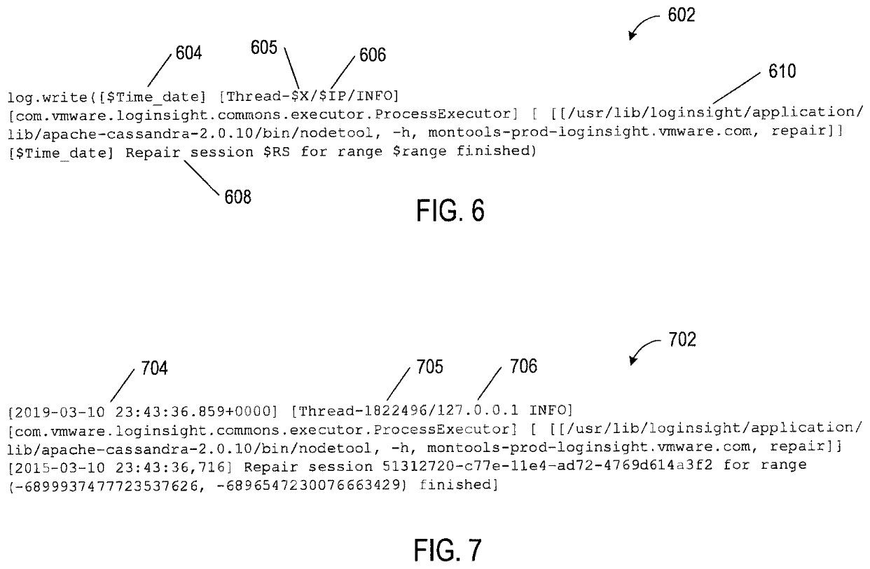

FIG. 6 shows an example of a log write instruction 602. The log write instruction 602 includes arguments identified with “$” that are filled at the time the log message is created. For example, the log write instruction 602 includes a time-stamp argument 604, a thread number argument 606, and an Internet protocol (“IP”) address argument 608. The example log write instruction 602 also includes text strings and natural-language words and phrases that identify the level of importance of the log message 610 and type of event that triggered the log write instruction, such as “Repair session” argument 612. The text strings between brackets “[ ]” represent file-system paths, such as path 614. When the log write instruction 602 is executed by a log management agent, parameters are assigned to the arguments and the text strings and natural-language words and phrases are stored as a log message of a log file.

FIG. 7 shows an example of a log message 702 generated by the log write instruction 602. The arguments of the log write instruction 602 may be assigned numerical parameters that are recorded in the log message 702 at the time the log message is executed by the log management agent. For example, the time stamp 604, thread 606, and IP address 608 arguments of the log write instruction 602 are assigned corresponding numerical parameters 704, 706, and 708 in the log message 702. Alphanumeric expression 1910 is assigned to a repair session argument 612. The time stamp 704 represents the date and time the log message 702 was generated. The text strings and natural-language words and phrases of the log write instruction 602 also appear unchanged in the log message 702 and may be used to identify the type of event (e.g., informative, warning, error, or fatal), also called an “event type,” that occurred during execution of the event source.

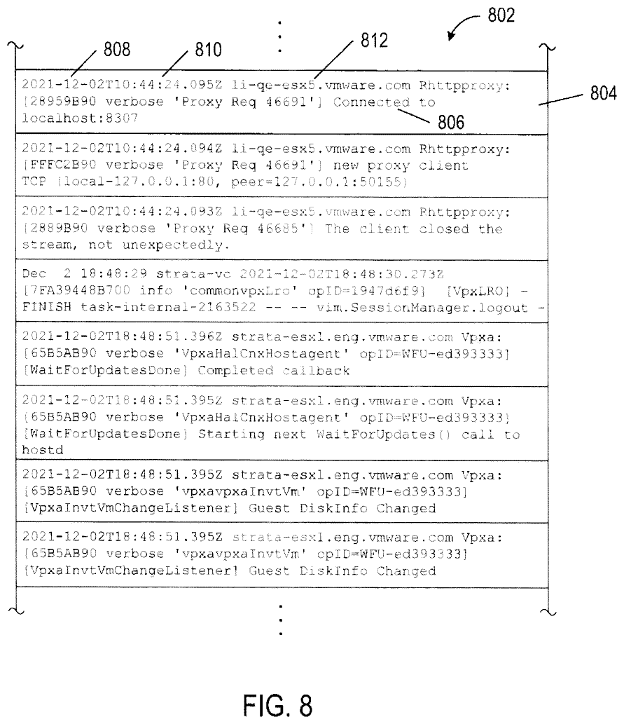

As log messages are received from various event sources, the log messages are stored in corresponding log files of the log database 314 in the order in which the log messages are received. FIG. 8 shows a small, eight-entry portion of a log file 802. In FIG. 8, each rectangular cell, such as rectangular cell 804, of the log file 802 represents a single stored log message. For example, log message 804 includes a short natural-language phrase 806, date 808 and time 810 numerical parameters, and an alphanumeric parameter 812 that identifies a particular host computer.

### Key Performance Indicators

The analytics engine 312 constructs certain key performance indicators (“KPIs”) of application performance and stores the KPIs in the KPI database 316. An application can have numerous associated KPIs. Each KPI of an application measures a different feature of application performance and is used by the analytics engine 312 to detect a particular performance problem. A KPI is a metric that can be constructed from other metrics and is used as an indicator of the health of an application executing in the data center. A KPI is denoted by

(y̅ₘ)ₘ₌₁^{M}=(y̅(tₘ))ₘ₌₁^{M} (1)

where
tₘ is a time stamp;
y̅ₘ=y̅(tₘ) is a metric value; and
M is the number of KPI values recorded over a time period.
   A distributed resource scheduling (“DRS”) score is an example of a KPI that is constructed from other metrics and is used to measure the performance level of a VM, container, or components of a distributed application. The DRS score is a measure of efficient use of resources (e.g., CPU, memory, and network) by an object and is computed as a product of efficiencies as follows:

$$y ( {t}_{m} ) = {EFFCY}_{CPU} ( {t}_{m} ) \times {EFFCY}_{Mem} ( {t}_{m} ) \times {EFFCY}_{Net} ( {t}_{m} ) \qquad ( 2 )$$

$$where$$

$${EFFCY}_{CPU} ( {t}_{m} ) = \frac{CPU usage ( {t}_{m} )}{Ideal CPU usage} ;$$

$${EFFCY}_{Mem} ( {t}_{m} ) = \frac{Memory usage ( {t}_{m} )}{Ideal Memory usage} ; and$$

$${EFCCY}_{Net} ( {t}_{m} ) = \frac{Network throughput ( {t}_{m} )}{Ideal Network throughput}$$

The metrics CPU usage(tₘ), Memory usage (tₘ), and Network throughput (tₘ) of an object are measured at points in time as described above with reference to Equation (2). Ideal CPU usage, Ideal Memory usage, and Ideal Network throughput are preset. For example, Ideal CPU usage may be preset to 30% of the CPU and Ideal Memory usage may be preset to 40% of the memory. DRS scores can be used for, example, as a KPI that measures the overall health of a distributed application by aggregating, or averaging, the DRS scores of each VM that executes a component of the distributed application.

Other examples of KPIs for an application include average response times to client request, error rates, contention time for resources, or a peak response time. Other types of KPIs can be used to measure the performance level of a cloud application. A cloud application is a distributed application with data storage and logical components of the application executed in a data center and local components provide access to the application over the internet via a web browser or a mobile application on a mobile device. For example, a KPI for an online shopping application could be the number of shopping carts successfully closed per unit time. A KPI for a website may be response times to customer requests. KPIs may also include latency in data transfer, troughput, number of packets dropped per unit time, or number of packets transmitted per unit time.

The analytics engine 312 detects performance problems by comparing a values of a KPI to a corresponding KPI threshold, denoted by Th_{KPI}. The corresponding KPI threshold Th_{KPI} can be a dynamic threshold that is automatically adjusted by the analytics engine 312 to changes in the application behavior over time or the threshold can be a fix threshold. When one or more metric values of the KPI violate the threshold, such as yᵢ>Th_{KPI} for an upper threshold, or yᵢ<Th_{KPI} for a lower threshold, the application is exhibiting a performance problem, the analytics engine 312 generates an alert that is displayed in the user interface 302.

### Event Types

The event type engine 306 extracts parametric and non-parametric strings of characters called tokens from log messages using regular expressions. A regular expression, also called “regex,” is a sequence of symbols that defines a search pattern in text data. Many regex symbols match letters and numbers. For example, the regex symbol “a” matches the letter “a,” but not the letter “b,” and the regex symbol “100” matches the number “100,” but not the number 101. The regex symbol “.” matches any character. For example, the regex symbol “.art” matches the words “dart,” “cart,” and “tart,” but does not match the words “art,” “hurt,” and “dark.” A regex followed by an asterisk “*” matches zero or more occurrences of the regex. A regex followed by a plus sign “+” matches one or more occurrences of a one-character regex. A regular expression followed by a questions mark “?” matches zero or one occurrence of a one-character regex. For example, the regex “a*b” matches b, ab, and aaab but does not match “baa.” The regex “a,+b” matches ab and aaab but does not match b or baa. Other regex symbols include a “\d” that matches a digit in 0123456789, a “\s” matches a white space, and a “\b” matches a word boundary. A string of characters enclosed by square brackets, [], matches any one character in that string. A minus sign “−” within square brackets indicates a range of consecutive ASCII characters. For example, the regex [aeiou] matches any vowel, the regex [a-f] matches a letter in the letters abcdef, the regex [0-9] matches a 0123456789, the regex [, . . . %+−] matches any one of the characters , . . . %+−. The regex [0-9a-f] matches a number in 0123456789 and a single letter in abcdef. For example, [0-9a-f] matches a6, i5, and u2 but does not match ex, 9v, or %6. Regular expressions separated a vertical bar “|” represent an alternative to match the regex on either side of the bar. For example, the regular expression Get|GetValue|Set|SetValue matches any one of the words: Get, GetValue, Set, or SetValue. The braces “{}” following square brackets may be used to match more than one character enclosed by the square brackets. For example, the regex [0-9]{2} matches two-digit numbers, such as 14 and 73 but not 043 and 4, and the regex [0-9]{1-2} matches any number between 0 and 99, such as 3 and 58 but not 349.

Simple regular expressions are combined to form larger regular expressions that match character strings of log messages and can be used to extract the character strings from the log messages. FIG. 9A shown a table of examples of regular expressions designed to match particular character strings of log messages. Column 902 list six different types of strings that may be found in log messages. Column 904 list six regular expressions that match the character strings listed in column 902. For example, an entry 906 of column 902 represents a format for a date used in the time stamp of many types of log messages. The date is represented with a four-digit year 908, a two-digit month 909, and a two-digit day 910 separated by slashes. The regex 912 includes regular expressions 914-916 separated by slashes. The regular expressions 914-916 match the characters used to represent the year 908, month 909, and day 910. Entry 918 of column 902 represents a general format for internet protocol (“IP”) addresses. A typical general IP address comprises four numbers. Each number ranges from 0 to 999 and each pair of numbers is separated by a period, such as 27.0.15.123. Regex 920 in column 904 matches a general IP address. The regex [0-9]{1-3} matches a number between 0 and 999. The backslash “\” before each period indicates the period is part of the IP address and is different from the regex symbol “.” used to represent any character. Regex 922 matches any IPv4 address. Regex 924 matches any base-10 number. Regex 926 matches one or more occurrences of a lower-case letter, an upper-case letter, a number between 0 and 9, a period, an underscore, and a hyphen in a character string. Regex 928 matches email addresses. Regex 928 includes the regex 926 after the ampersand symbol.

In another implementation, the event-type engine 306 extracts non-parametric tokens from log messages using Grok expressions that are constructed from Grok patterns. Grok patterns are predefined symbolic representations of regular expressions that reduce the complexity of constructing regular expressions. Grok patterns are categorized as either primary Grok patterns or composite Grok patterns that are formed from primary Grok patterns. A Grok pattern is called and executed using the notation Grok syntax % {Grok pattern}.

FIG. 9B shows a table of examples of primary Grok patterns and corresponding regular expressions. Column 932 contains a list of primary Grok patterns. Column 934 contains a list of regular expressions represented by the Grok patterns in column 932. For example, the Grok pattern “USERNAME” 936 represents the regex 938 that matches one or more occurrences of a lower-case letter, an upper-case letter, a number between 0 and 9, a period, an underscore, and a hyphen in a character string. Grok pattern “HOSTNAME” 940 represents the regex 942 that matches a hostname. A hostname comprises a sequence of labels that are concatenated with periods. Note that the list of primary Grok patterns shown in FIG. 9 is not an exhaustive list of primary Grok patterns.

Grok patterns may be used to map specific character strings into dedicated variable identifiers. Grok syntax for using a Grok pattern to map a character string to a variable identifier is given by:

% {GROK_PATTERN:variable_name}

where
GROK_PATTERN represents a primary or a composite Grok pattern; and
variable_name is a variable identifier assigned to a character string in text data that matches the GROK_PATTERN.

A Grok expression is a parsing expression that is constructed from Grok patterns that match characters strings in text data and may be used to parse character strings of a log message. Consider, for example, the following simple example segment of a log message:

34.5.243.1 GET index.html 14763 0.064

A Grok expression that may be used to parse the example segment is given by:

\hat{ }%{IP:ip_address}\s%{WORD:word}\s%{URIPATHPARAM:request}\s %{INT:bytes}\s%{NUMBER:duration}$

The hat symbol “A” identifies the beginning of a Grok expression. The dollar sign symbol “$” identifies the end of a Grok expression. The symbol “\s” matches spaces between character strings in the example segment. The Grok expression parses the example segment by assigning the character strings of the log message to the variable identifiers of the Grok expression as follows:
ip_address: 34.5.243.1
word: GET
request: index.html
bytes: 14763
duration: 0.064

Different types of regular expressions or Grok expressions are configured to match token patterns of log messages and extract tokens from the log messages. Numerous log messages may have different parametric tokens but the same set of non-parametric tokens. The non-parametric tokens extracted from a log message describe the type of event, or event type, recorded in the log message. The event type of a log message is denoted by Eᵢ, where subscript i is an index that distinguishes the different event types of log messages. Many event types correspond to benign events recorded in log message while event types that describe errors, warning or critical problems are identified by the operation management server 132.

FIG. 9C shows an example of a Grok expression 944 used to extract tokens from a log message 946. Dashed directional arrows represent parsing the log message 946 such that tokens that correspond to Grok patterns of the Grok expression 944 are assigned to corresponding variable identifiers. For example, dashed directional arrow 948 represents assigning the time stamp 2021-07-18T06:32:07+00:00 950 to the variable identifier timestamp_iso8601 952 and dashed directional arrow 954 represents assigning HTTP response code 200 956 to the variable identifier response code 958. FIG. 9C shows assignments of tokens of the log message 946 to variable identifiers of the Grok expression 944. The combination of non-parametric tokens 960-962 identify the event type 964 of the log message 946. Parametric tokens 966-968 may change for different log messages with the same event type 964.

### Automated Methods and System for Resolving Performance Problems with Applications Executing in a Data Center

A KPI reveals performance problems of an application. One the other hand, log messages can provide contextual information about the performance problems discovered with the KPI. The analytics engine 312 uses machine learning as described below to train an inference model that relates events recorded in log messages to KPI values of the KPI. The analytics engine 312 uses the inference model to determine which events recorded in log messages identify a probable root cause of a performance problem revealed by the KPI. The inference model can also be used to identify log messages that impact performance of data center objects.

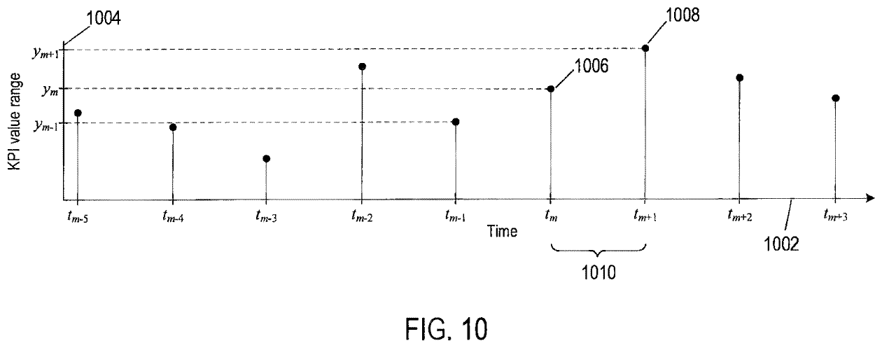

FIG. 10 shows an example plot of a KPI associated with an object executing in a data center. The object can be an application, rnicroservice of a distributed application, a VM, a container, computer hardware, such as a host or switch. The analytics engine 312 measures the KPI in monitoring intervals and stores the KPI values in the metrics database 316. Horizontal line 1002 represents a time axis. Vertical axis 1004 represents a range of KPI values. The time axis 1002 is partitioned into time intervals. For example, each time interval may represent one day, 12 hours, 8 hours, 1 hour, or 5 minutes depending on the KPI. Solid dots represent KPI values. A KPI value is produced at the end of each time interval. Solid dots 1006 represents KPI value yₘ, and solid dot 1008 represents KPI value yₘ₊₁. For example, the time interval 1010 may represents one day and the KPI is the average response time of an application to customer requests over one day. Alternatively, the KPI values, such as KPI values yₘ 1006 and yₘ₊₁ 1008, may represent the average response time of the website measured in three-hour time intervals. KPI value yₘ₊₁ 1008 indicates an increase in response times to customer requests in the time interval 1010, which may be an indication of degradation of the object or a high traffic volume. The KPI indicates a performance problem, but the KPI does not reveal the cause of the behavior.

The analytics engine 312 normalizes the KPI in Equation (1) to prevent KPI values with large values from dominating the model building process described below. In one implementation, KPI values are normalized to the interval [0,1] by

$${\tilde{y}}_{m} = \frac{{\overline{y}}_{m} - min ( {\overline{y}}_{m} )}{max ( {\overline{y}}_{m} ) - min ( {\overline{y}}_{m} )} \qquad ( 3 a )$$

where
min(y̅ₘ) is the minimum KPI value of the time period; and
max(y̅ₘ) is the maximum KPI value of the time period.

In another implementation, KPI values are normalized by

$${\tilde{y}}_{m} = \frac{{\overline{y}}_{m} - μ}{σ} \qquad ( 3 b )$$

where the mean of the j-th metric is given by

$$μ = \frac{1}{M} {\sum }_{j = 1}^{M} {\overline{y}}_{j}$$

and the standard deviation of the j-th metric is given by

$$σ = \sqrt{\frac{1}{M} {\sum }_{m = 1}^{M} {( {\overline{y}}_{m} - μ )}^{2}}$$

The sequence of normalized KPI values in the time period associated with the selected application are denoted by

(yₘ)ₘ₌₁^{M}=(y(tₘ))ₘ₌₁^{M} (4)

The analytics engine 312 computes a probability distribution of event types of log messages produced in the time intervals between consecutive KPI values. Let N be the total number of event types that can be extracted from log messages generated by event sources associated with the object. The event type engine 306 determines the event type of each log message produced in the rn-th time interval that precedes the m-th KPI value. For example, the analytics engine 312 computes a probability distribution of event types generated in the interval 1010 preceding the KPI value 1008. The analytics engine 312 computes the number of times each event type appeared in the time interval. Let n(etₘₙ) denote an event type counter of the number of times the event type etₘₙ occurred in the time interval, where n is an event lime index with n=1, . . . , N. Note that certain event types may not occur in a given time interval. In these cases, n(etₘₙ)=0. The analytics engine 312 computes an event-type probability for each of the N event types:

$${p}_{mn} = \frac{n ( {et}_{mn} )}{N} \qquad ( 5 )$$

The analytics engine 312 forms an event-type probability distribution from event-type probabilities the m-th time interval:

Pₘ=(pₘ₁, pₘ₂, . . . , p_{m,N-1}, p_{mN}) (6)

where m=1, . . . , M.

The probability distribution in Equation (6) contains an event-type probability for each of the N event types that may occur in the m-th time interval. As a result, a number of the probabilities in the probability distribution (6) may be equal to zero.

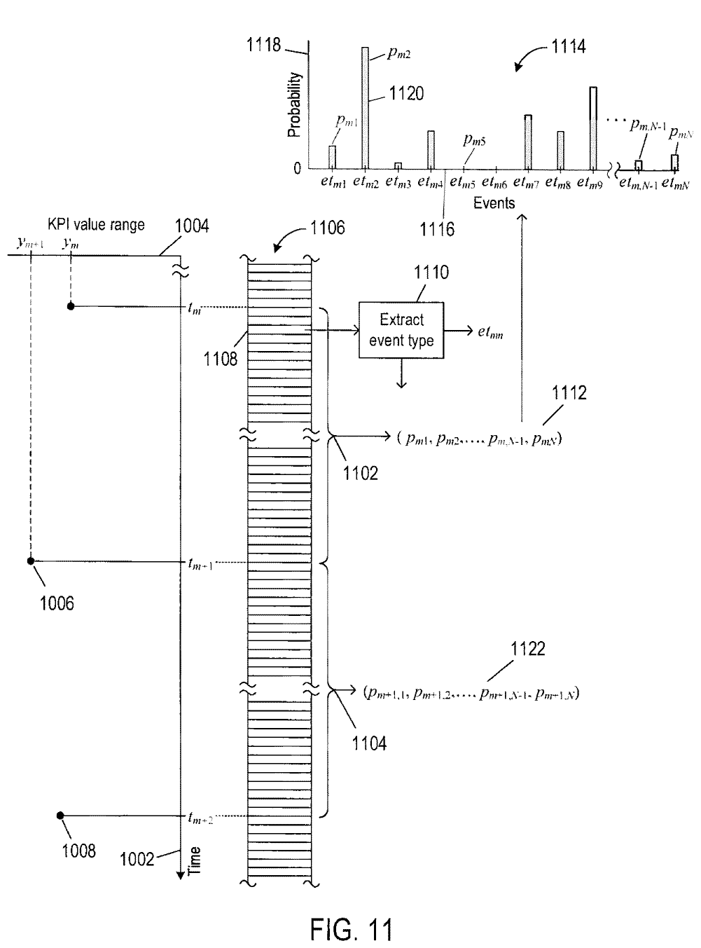

FIG. 11 shows construction of example event-type probability distributions for two consecutive time intervals. FIG. 11 shows a portion of the time axis 1002 and the KPI values 1006 and 1008 shown in FIG. 10. The duration of the time intervals between KPI values is denoted by Δ. The time interval 1102 that precedes the KPI value 1006 is denoted by [tₘ, tₘ+Δ). The time interval 1104 that precedes the KPI value 1008 is denoted by [tₘ+Δ, tₘ+2Δ) and corresponds to the time interval 1010 in FIG. 10. FIG. 11 also shows a portion of a log file 1106 that contains log messages with time stamps in the interval [tₘ, tₘ+2Δ). Each log message in the log file 1106 is represented by a rectangle. For example, rectangle 1108 represents a log message with a time stamp in the time interval [tₘ, tₘ+Δ) 1102. Block 1110 represents extraction of event types from a log message 1108 to obtain event type etₘₙ by the even type engine 306 described above. The event type engine 306 extracts the event type from each of the log messages. The analytics engine 312 computes a probability distribution from the event types extracted in the time intervals as described above with reference to Equations (5) and (6). Probability distribution 1112 represents the probabilities of the event types in the time interval 1102. FIG. 11 shows an example plot 1114 of the event-type probabilities of the probability distribution 1112. Horizonal line 1116 represents the range of event types. Vertical line 1118 represents the range of probabilities. Bars represent the probabilities of different event types. For example, bar 1120 represents the value of the probability pₘ₂ of the event type etₘ₂ occurring in the time interval 1102. The probability distribution 1112 includes zero probabilities that correspond to event types that did not occur in the time interval 1102. For example, the probability pₘ₅ of the event type etₘ₅ is zero because log messages with the event type etₘ₅ were not generated in the time interval 1102. Probability distribution 1122 represents the probabilities of the event types of log messages recorded in the time interval 1102.

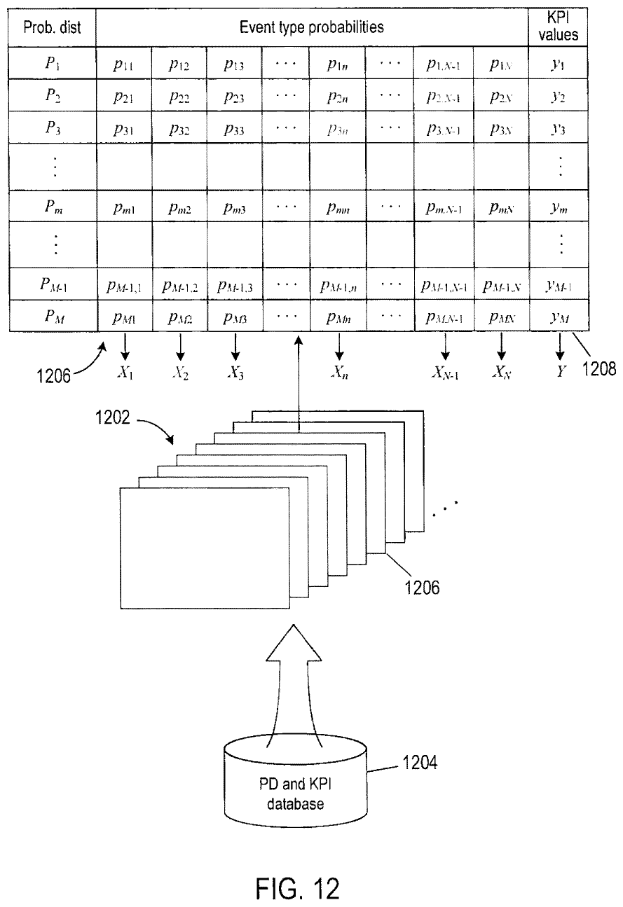

The analytics engine 312 stores the probability distributions and corresponding KPI values in a data frame of a probability distributions and KPI database. FIG. 12 shows data frames 1202 of probability distributions and KPI values stored in a probability distributions and KPI database 1204. Each data frame contains the probability distributions and KPI labels of a different KPI. For example, FIG. 12 shows an exploded view of data frame 1206 that is stored in the database 1204 and records M probability distributions and corresponding KPI values of a KPI. Each column contains the event-type probabilities of an event type etₙ and is denoted by

Xₙ(p₁ₙ, p₂ₙ, . . . , pₘₙ, . . . , p_{Mn})^{T} (7)

where n=1, . . . , N.

Column 1208 of the data frame 1206 records the normalized KPI values of the KPI. The normalized KPI values of the KPI are given by

Y=(y₁, y₂, . . . , yₘ, . . . , y_{M})^{T} (8)

The analytics engine 312 uses machine learning to train an inference model that relates the N event-type probabilities {Xⱼ}ⱼ₌₁^{N}, or events, to a corresponding KPI Y. The inference model can be a parametric inference model or a non-parametric inference model. The inference model is used to determine a root cause of a performance problem recorded in run-time KPI values of the application, predict the health of the application, and generate recommended remedial measures for correcting the performance problem with the application. The operations manager executes one or more selected recommended remedial measures to correct the performance problem, which optimizes performance of the application.

The analytics engine 312 trains a parametric inference model for the application with the N event-type probabilities {Xⱼ}ⱼ₌₁^{N} as inputs, called “predictors,” and the KPI Y as an output, called the “response.” The relationship between the event-type probabilities {Xⱼ}ⱼ₌₁^{N} and the KPI Y is represented by

Y=ƒ({Xⱼ}ⱼ₌₁^{N})+ϵ (9)

where ϵ represents a random error that is independent of the event-type probabilities {Xⱼ}ⱼ₌₁^{N} and has a mean zero and is normally distributed.
Here ƒ denotes an unknown model of the relationship between the event-type probabilities and the KPI.

In one implementation, the unknown model in Equation (9) is a linear parametric function given by

$$f ( {\{ {X}_{j} \}}_{j = 1}^{N} ) = \tilde{X} β = {β}_{0} + {\sum }_{j = 1}^{N} {β}_{j} {X}_{j} \qquad ( 10 )$$

where β₀, β₁, . . . , βₙ are model coefficients.

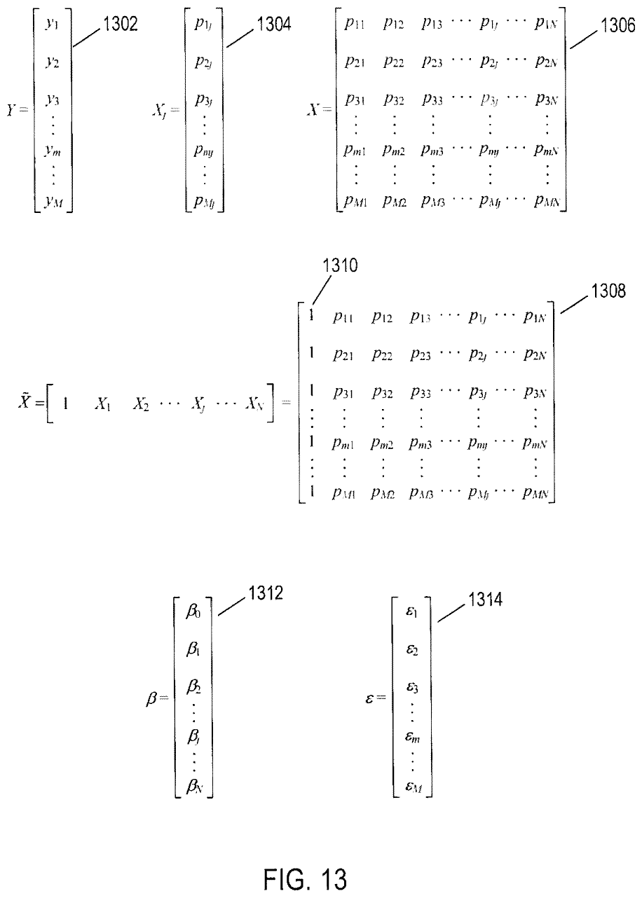

FIG. 13 shows matrix representations of the parametric model in Equation (10). Column matrix 1302 contains the KPI values of the KPI Y as described above with reference to FIG. 12. Column matrix 1304 contains event-type probabilities the event type etⱼ as described above with reference to FIG. 12. Matrix X 1306 is a matrix formed from the N event types. Matrix \tilde{X} 1308 in Equation (10) is called a design matrix. The design matrix \tilde{X} contains a first column 1310 of ones combined with the matrix X 1306. Column matrix β 1312 contains the model coefficients. Column matrix ϵ 1314 contains the random errors for each time stamp.

The analytics engine 312 uses the event-type probabilities {Xⱼ}ⱼ₌₁^{N} and the KPI Y to train a parametric model \hat{ƒ} that estimates ƒ for any (X, Y) and is given by

$$\hat{Y} = \hat{f} ( X ) = \tilde{X} \hat{β} = {\hat{β}}_{0} + {\sum }_{j = 1}^{N} {\hat{β}}_{j} {X}_{j} \qquad ( 11 )$$

where the hat symbol, \hat{ }, denotes an estimated value.

Column matrix \hat{β} contains estimated model coefficients \hat{β}₀, \hat{β}₁, . . . , \hat{β}_{N}, which are estimates of corresponding model coefficients β₀, β₁, . . . , β_{N}, and Ŷ is an estimate of the KPI Y. The analytics engine 312 executes least square to compute the estimated model coefficients as follows:

\hat{β}=(\tilde{X}^{T}\tilde{X})⁻¹\tilde{X}^{T}Y (12)

where superscript −1 denotes matrix inverse.

Substituting Equation (12) into Equation (11) gives the following transformation between the actual KPI Y and the estimated KPI Ŷ:

Ŷ=\tilde{X}\hat{β}=\tilde{X}(\tilde{X}^{T}\tilde{X})⁻¹\tilde{X}^{T}Y=HY (13)

In one implementation, the analytics engine 312 executes hypothesis testing to determine whether there is a linear relationship between the parametric model obtained in Equation (11) and the KPI and whether at least one of the event types is useful in predicting the KPI. The null hypothesis is

H₀; β₁=β₂= . . . =β_{N}=0

versus the alternative hypothesis

H_{α}: at least one βⱼ≠0

A test for the null hypothesis is performed using the F-statistic given by:

$${F}_{0} = \frac{{MS}_{R}}{{MS}_{E}} \qquad ( 14 a )$$

$$where$$

$${MS}_{R} = \frac{{SS}_{R}}{p}$$

is the regression mean square, and

$${MS}_{E} = \frac{{SS}_{E}}{M - N - 1}$$

is the error mean square. The numerator of the regression mean square is given by

$${SS}_{R} = {Y}^{T} ( H - ( \frac{1}{M} ) J ) Y$$

where H is the matrix given in Equation (12) and the matrix J is an M×M square matrix of ones. The numerator of the error mean square is given by

SS_{E}=Y^{T}(I_{M×M}−H)Y

where I_{M×M} is the M×M identity matrix. The operations manager rejects the null hypothesis when the F-statistic is larger than a threshold. Th_{F}, represented by the condition:

F₀>Th_{F} (14b)

In other words, when the condition in Equation (14b) is satisfied, at least one of the event-type probabilities is related to the KPI. The threshold Th_{F} may be preselected by a user. Alternatively, the threshold may be set to the f-distribution:

Th_{F}=ƒ_{α,N,M-N-1} (14c)

The subscript α is a non-zero probability that may be set to a value less than or equal to 0.10 (i.e., 0<α<1 and α is the area of the tail of the f-distribution computed with degrees of freedom M and M−N−1).

If it is determined that the null hypothesis for the estimated model coefficients is rejected, it may still be the case that one or more of the event-type probabilities are irrelevant and not associated with the KPI Y. Including irrelevant event-type probabilities in the computation of the estimate KPI Ŷ leads to unnecessary complexity in the final parametric model. The analytics engine 312 deletes irrelevant event-type probabilities (i.e., setting corresponding estimated model coefficients to zero in the parametric inference model) to obtain a parametric inference model based on event-type probabilities that more accurately relate to the KPI Y.

In another implementation, when the analytics engine 312 has determined that at least one of the event-type probabilities is relevant, the analytics engine 312 executes hypothesis testing to separately assesses the significance of the estimated model coefficients in the parametric model. The null hypothesis for each estimated model coefficient is

H₀: βⱼ=0

versus the alternative hypothesis

H_{α}: βⱼ≠0

The t-test is a test statistic that is based on the t-distribution. For each estimated model coefficient, the t-test is computed as follows:

$${T}_{j} = \frac{{\hat{β}}_{j}}{SE ( {\hat{β}}_{j} )} \qquad ( 15 a )$$

where SE(\hat{β}ⱼ) is the estimated standard error of the estimated coefficient \hat{β}ⱼ.

The estimated standard error for the j-th estimated model coefficient. \hat{β}ⱼ, may be computed from the symmetric matrix

C=\hat{σ}²(X^{T}X)⁻¹

where

\hat{σ}²=MS_{E} (15b)

The estimated standard error SE(\hat{β}ⱼ)=\sqrt{Cⱼⱼ,} where Cⱼⱼ the j-th diagonal element of the matrix C. The null hypothesis is rejected when the t-test satisfies the following condition:

−Th_{T}<Tⱼ<Th_{T} (15c)

In other words, when the condition in Equation (15c) is satisfied, the event type of the event-type probabilities Xⱼ is related to the KPI Y. The threshold Th_{T} may be preselected by a user. Alternatively, the threshold may be set to the t-distribution:

Th_{T}=t_{γ,M-2} (15d)

The subscript γ is a non-zero probability that may be set to a value less than or equal to 0.10 (i.e., 0<γ<1 and γ is the area of the tails of the t-distribution computed with degrees of freedom M−2). Alternatively, when the following condition is satisfied

Tⱼ≤−Th_{T} or Th_{T}≤Tⱼ (15e)

the event type of the event-type probabilities Xⱼ is not related to the KPI Y (i.e., the event type etⱼ is irrelevant) and the estimated model coefficient \hat{β}ⱼ is set to zero in the parametric model. When one or more event types have been identified as being unrelated to the KPI Y, the model coefficients may be recalculated according to Equation (14) with the irrelevant event-type probabilities omitted from the design matrix \tilde{X} and corresponding model coefficients omitted from the process. The resulting parametric model is the trained parametric inference model.

In another implementation, rather than eliminating event types based on hypothesis testing, the analytics engine 312 executes a backward stepwise selection process to train a parametric model with estimated model coefficients of relevant event-type probabilities. The backward stepwise process is a step-by-step process of eliminating irrelevant event-type probabilities from the set of event-type probabilities {Xⱼ}ⱼ₌₁^{N} and thereby produces a parametric model that has been trained only with relevant metrics. The process begins by partitioning the data frame 1206 into a training set and a validation set.

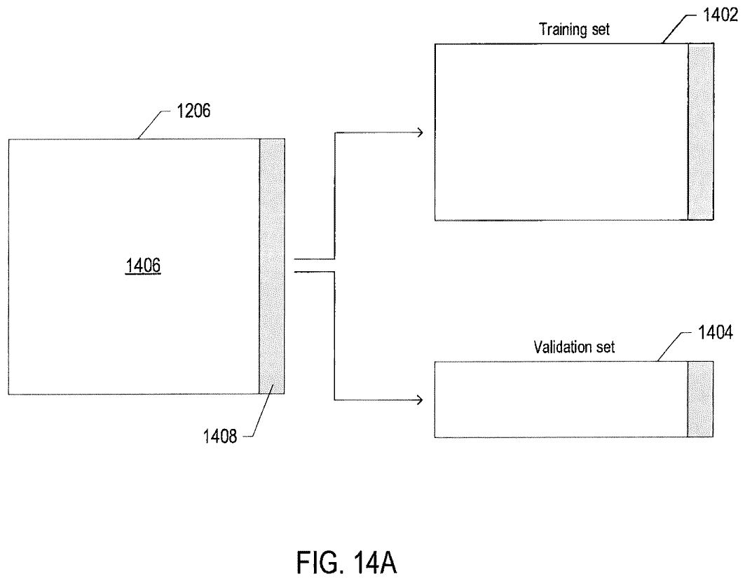

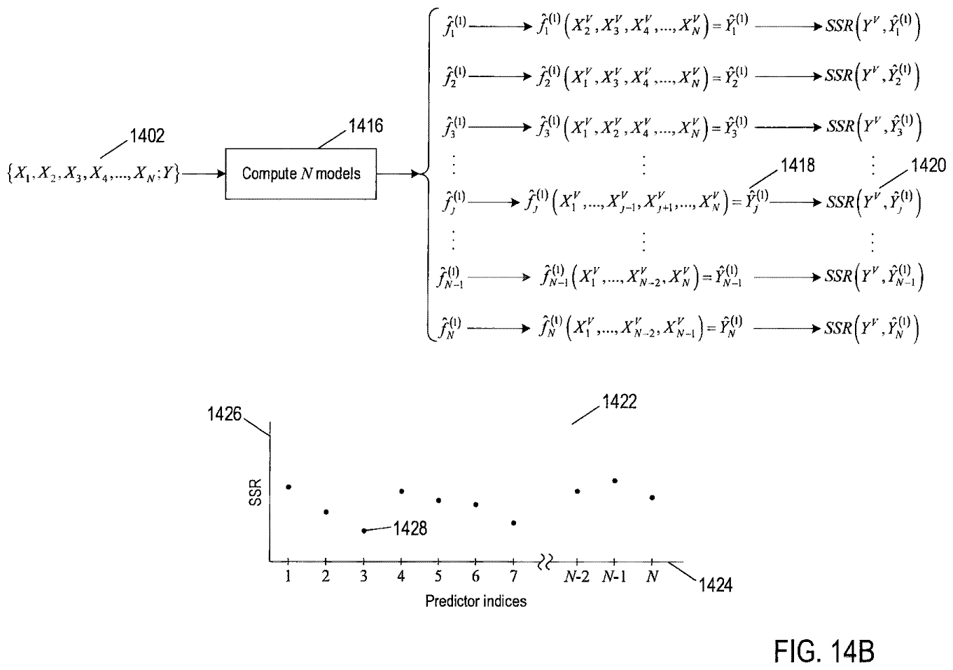

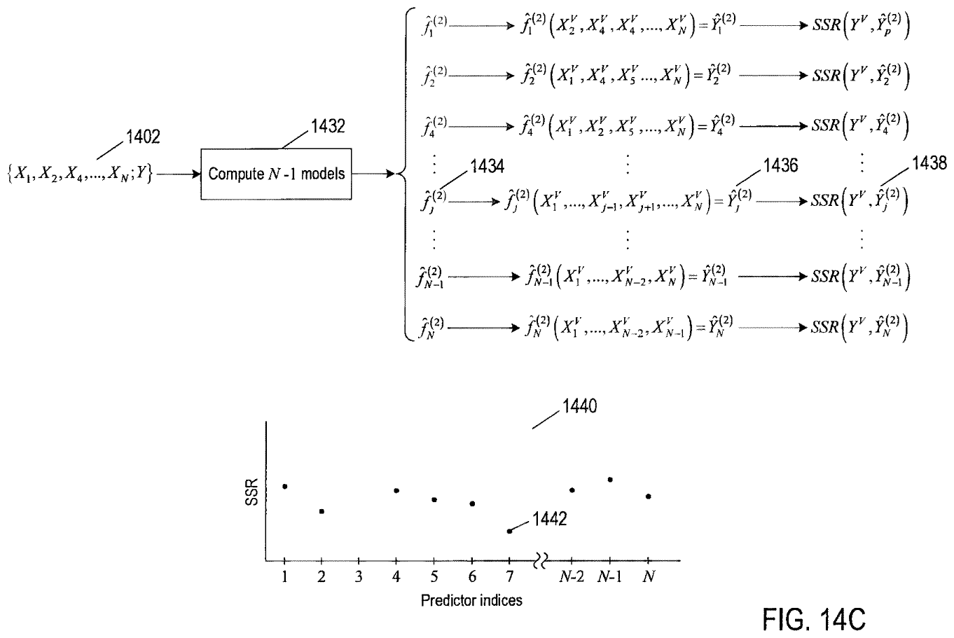

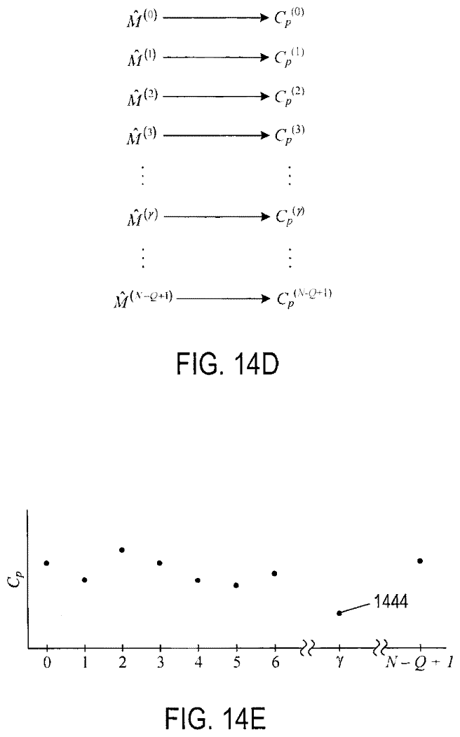

FIG. 14A shows an example of the data frame 1206 partitioned into training set 1402 and a validation set 1404. Unshaded rectangle 1406 represents the set of event-type probabilities {Xⱼ}ⱼ₌₁^{N} of the data frame 1206 of FIG. 12. Shaded rectangle 1408 represents the KPI value in column 1408. The training set 1408 is composed of randomly selected probability distributions and corresponding KPI values. The validation set 1410 is composed of the remaining probability distributions and corresponding KPI values.

A full model \hat{M}⁽⁰⁾ is initially computed with the full training set 1402 using least squares as described about with reference to Equations (11) and (12), where superscript (0) indicates that none of the N event-type probabilities have been omitted from the training set 1402 in determining the model \hat{M}⁽⁰⁾ (i.e., \hat{M}⁽⁰⁾=\hat{ƒ}). For each step q=N, N−1, . . . , Q a set of parametric models denoted by {\hat{ƒ}₁^{(γ)}, \hat{ƒ}₂^{(γ)}. . . , \hat{ƒ}_{q}^{(γ)}} is computed using least squares as described above with reference to Equations (11) and (12) but with event-type probabilities Xⱼ of a different event type etⱼ omitted from the training set 1402 for each model, where γ=1, 2, . . . , N−Q+1 represents the number of event types with corresponding event-type probabilities that have been omitted from the training set and Q is a user selected positive integer less than r (e.g., Q=1). At each step q, an estimated KPI, \hat{ƒ}ⱼ^{(γ)} (X^{V})=Ŷⱼ^{(γ)}, is computed using the event-type probabilities and corresponding KPIs of the validation set 1404 for each of the q parametric models to obtain a set of estimated KPIs {Ŷ₁^{(γ)}, Ŷ₂^{(γ)}, . . . , Ŷ_{q}^{(γ)}}. A sum of squared residuals (“SSR”) is computed for each estimated KPI and the KPI of the validation set as follows:

$$SSR ( {Y}^{V} , {\hat{Y}}_{mj}^{( γ )} ) = {\sum }_{m = 1}^{M} ( {y}_{m}^{V} - {\hat{Y}}_{mj}^{( γ )} {)}^{2} \qquad ( 16 )$$

### Where

superscript “V” is added to identify KPI values of the validation set 1404:
yₘ^{V} is the n-th KPI value in the KPI Y^{V};
ŷₘ^{(γ)} is the in-th KPI value in the estimated KPI Ŷⱼ^{(γ)}; and
j=1, . . . , q.
   Let \hat{M}^{(γ)} denote the model, such as model \hat{ƒ}ⱼ^{(γ)} (X^{V}), with the smallest corresponding SSR denoted by

SSR(γ)=min {SSR(Y^{V}, Ŷ₁^{(γ)}), . . . , SSR(Y^{V}, Ŷ_{q}^{(γ)})}

The stepwise process terminates when q=Q. For each step q, the resultant parametric model \hat{M}^{(γ)} has been determined for q−γ metrics that produce the smallest errors. The final parametric model \hat{M}^{(N-Q+1)} has been determined with Q−1 event-type probabilities that have the smallest SSRs. The stepwise process produces a set of parametric models denoted by M={\hat{M}⁽⁰⁾, \hat{M}⁽¹⁾, . . . , \hat{M}^{(N-Q+1)}}. Except for the full model \hat{M}⁽⁰⁾, each of the models in the set M has been computed by omitting one or more event-type probabilities of irrelevant event types. The model in the set M with the best fit to the validating set is determined by computing a Cₚ-statistic for each model in the set Al as follows:

$${C}_{p}^{( V )} = \frac{1}{M} ( SSR ( γ ) + 2 d {\hat{σ}}^{2} ) \qquad ( 17 )$$

where
d is the number of event types with event-type distributions in the corresponding model \hat{M}^{(γ)};
\hat{σ}² is the variance of the full model \hat{M}⁽⁰⁾ given by Equation (15b); and
j=1, . . . , N−Q+1.
   The Cₚ-statistic for the full model \hat{M}⁽⁰⁾ is given by SSR(Y^{V}, Ŷ₁⁽⁰⁾). The parametric model with the smallest corresponding Cₚ-statistic is the resulting trained parametric model.

FIGS. 14B-14E show an example of training a parametric model using the backward stepwise process described above. In FIG. 14B, for a first step q=N, block 1416 represents computing a set of N models, {\hat{ƒ}₁⁽¹⁾, \hat{ƒ}₂⁽¹⁾, . . . , \hat{ƒ}_{N}⁽¹⁾}. Model \hat{ƒ}ⱼ⁽¹⁾ is computed using least squares as described above with reference to Equations (11) and (12) with the event-type probabilities Xⱼ omitted from the training set 1408 for j=1, . . . , N. Estimated KPIs are computed for each of the N models {Ŷ₁⁽¹⁾, Ŷ₂⁽¹⁾, . . . , Ŷ_{N}⁽¹⁾}, where Ŷⱼ⁽¹⁾ 1418 is computed for \hat{ƒ}ⱼ⁽¹⁾ using least squares as described above with reference to Equations (11) and (12) with the metric Xⱼ^{V} omitted from the validating set 1404. An SSR is computed for each of the models according to Equation (16). For example, SSR (Y^{V}, Ŷⱼ⁽¹⁾) 1420 is computed for the model \hat{ƒ}ⱼ⁽¹⁾ in accordance with Equation (16). FIG. 14B includes a plot 1422 of example SSR values for the N parametric models. Horizontal axis 1424 represents the model indices. Vertical axis 1426 represents a range of SSR values. Points represent the SSR values for the N parametric models. In this example plot, point 1428 is the minimum SSR that corresponds to the model \hat{ƒ}₃⁽¹⁾, where the event-type probabilities X₃ of the event type et₃ has been omitted from the training set 1808. The resulting model for the first step is \hat{M}⁽¹⁾=\hat{ƒ}₃⁽¹⁾. As a result, the metric X₃ is regarded as irrelevant and discarded from the training set 2008 prior to proceeding to the next step with q=p−1.

In FIG. 14C, for a second step q=N−1, block 1432 represents computing a set of N−1 models, {\hat{ƒ}₁⁽²⁾, \hat{ƒ}₂⁽²⁾, \hat{ƒ}₄⁽²⁾ . . . , \hat{ƒ}_{N}⁽²⁾}, where the model coefficient, \hat{β}₃, associated with irrelevant event type et₃ has been omitted. Model \hat{ƒ}ⱼ⁽²⁾ 1434 is computed using least squares as described above with reference to Equations (11) and (12) with the event-type probabilities X₃ omitted from the training set 1402. Estimated KPIs are computed for each of the N−1 models {Ŷ₁⁽²⁾, Ŷ₂⁽²⁾, Ŷ₄⁽²⁾, . . . , Ŷ_{N}⁽²⁾}, where Ŷⱼ⁽²⁾ 1436 is computed using \hat{ƒ}ⱼ⁽²⁾ with the event-type probabilities X₃^{V} omitted from the validation set 1404. An SSR is computed for each of the models according to Equation (16). For example, SSR(Y^{V}, Ŷⱼ⁽²⁾) 1439 is computed for the model \hat{ƒ}ⱼ⁽²⁾ in accordance with Equation (16). FIG. 14C includes a plot 1440 of example SSR values for the N−1 models. In this example plot, point 1442 is the minimum SSR that corresponds to the model \hat{ƒ}₇⁽²⁾. The resulting parametric model for the second step is \hat{M}⁽²⁾=\hat{ƒ}₇⁽²⁾. As a result, the event type et₇ with event-type probabilities X₇ is regarded as irrelevant and discarded from the training set 1402 prior to proceeding to the next step with q=N−2.

The stepwise process of removing irrelevant metrics is repeated for q=N−2, . . . , Q to obtain a set of candidate models M={\hat{M}⁽⁰⁾, \hat{M}⁽¹⁾, . . . , \hat{M}^{(N-Q+1)}}. A Cₚ-statistic is computed for each of the models in the set M as described above with reference to Equation (17). FIG. 14D shows an example of Cₚ-statistics obtained for each of the models. FIG. 14E shows a plot of example Cₚ-statistics. The parametric model associated with the minimum of the Cₚ-statistics is the trained parametric inference model. In this example, point 1444 represents the minimum Cₚ-statistics, indicating that corresponding parametric model \hat{M}^{(γ)} is the trained parametric inference model.

In another implementation, the operations manager performs k-fold cross validation to obtain a trained parametric inference model. With k-fold cross validation, a set of metrics X and corresponding KPI Y are randomized and divided into k groups called “folds” of approximately equal size. A fold is denoted by (X̅ₗ, Y̅ₗ), where X̅ₗ⊂X, Y̅ₗ⊂Y, the overbar denotes a subset of metrics X̅ₗ and corresponding KPI Y̅ₗ and subscript l is a fold index with l=1, . . . , k. For each fold l, (X̅ₗ, Y̅ₗ) is treated as a validating set, and a parametric model denoted by \hat{ƒ}ₗ is fit to the remaining k—1 folds using least squares described above Equations (11) and (12). For the l-th fold, an estimated KPI is computed with \hat{ƒ}ₗ(X̅ₗ)=Ŷₗ. A mean squared error (“MSE”) is computed for the estimated KPI and the KPI of the validating set as follows:

$$MSE ( {\hat{Y}}_{l} , {\ddot{Y}}_{l} ) = \frac{1}{M} {\sum }_{m = 1}^{M} {( {\overline{y}}_{m l} - {\hat{y}}_{m l} )}^{2} \qquad ( 18 a )$$

where
y̅ₘₗ is the m-th KPI value of the validating KPI Y̅ₗ; and
ŷₘₗ is the m-th KPI value of the estimated KPI Ŷₗ.
   The mean square errors are used to compute a k-fold cross-validation estimate:

$$C {V}_{k} = \frac{1}{k} {\sum }_{l = 1}^{k} MSE ( {\hat{Y}}_{ι} , {\overline{y}}_{l} ) \qquad ( 18 b )$$

When the k-fold cross validation estimate satisfies the condition

CVₖ<Th_{CV} (18e)

where Th_{CV} is a user-defined threshold (e.g., Th_{CV}=0.10 or 0.15), for each of the parametric models {\hat{ƒ}₁, . . . , \hat{ƒ}ₖ}, model coefficients of a trained parametric model are obtained by averaging the model coefficients of the k models as follows:

$${\hat{β}}_{j} = \frac{1}{k} {\sum }_{l = 1}^{k} {\hat{β}}_{jl} \qquad ( 18 d )$$

for j=0, 1, . . . , N.

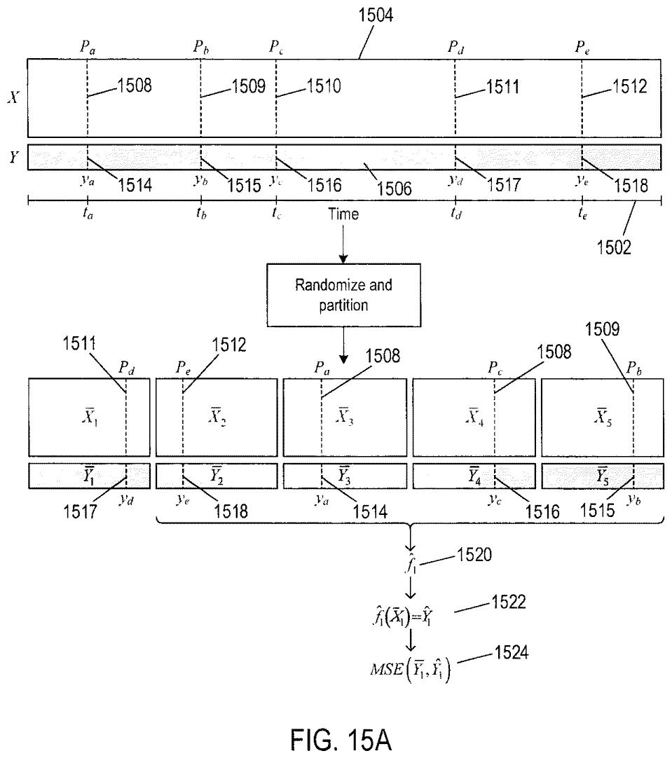

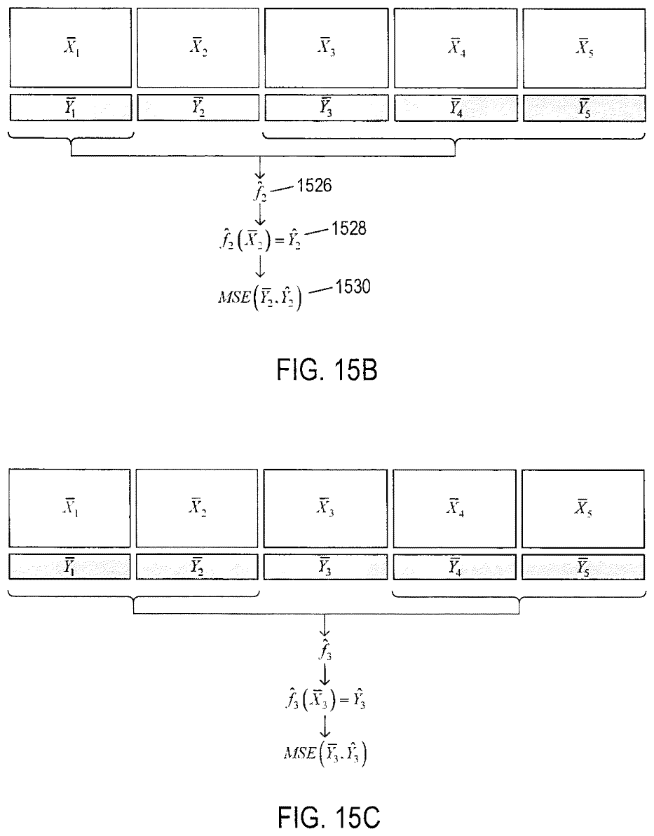

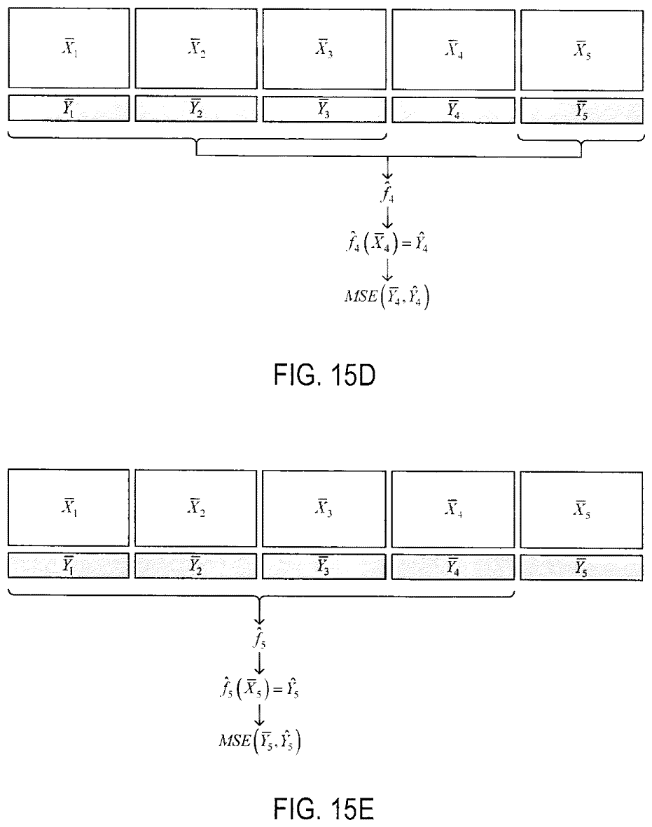

FIGS. 15A-15F shove of an example of k-fold cross validation applied to an example set of metrics and KPI for k=5. In FIG. 15A, line 1502 represents a time window. Block 1504 represents a set of p metrics X recorded in the time window 1502. Shaded block 1506 represents KPI values fora KPI recorded in the time window 1502. The metrics X and KPI Y have been normalized and synchronized as described above. Dashed lines 1508-1512 denote metric values of five p-tuples x₁, x₂, x₃, x₄, and x₅ of the metrics with time stamps t₁, t₂, t₃, t₄, and t₅. Dashed lines 1514-1518 represent KPI values y₁, y₂, y₃, y₄, and y₅ with the time stamps t₁, t₂, t₃, t₄, and t₅. In this example, the metrics and corresponding KPI values at the same time stamps are randomized and partitioned into 5-folds. The metrics of the 5-folds are denoted by X̅₁, X̅₂, X̅₃, X̅₄, and X̅₅ (i.e., X̅₁∪X̅₂∪X̅₂∪X̅₄∪X̅₅=X) and the corresponding KPIs are denoted by Y̅₁, Y̅₂, Y̅₃, Y̅₄, and Y̅₅ (i.e., Y̅₁∪Y̅₂∪Y̅₃∪Y̅₄∪Y). Randomization scrambles the p-tuples and corresponding KPI values. For example, randomization places the p-tuples x₁ 1508 and corresponding KPI value y₁ 1514 in the third fold (X̅₃, Y̅₃). For the first iteration in FIG. 15A. the first fold (X̅₁, Y̅₁) is the validating set and a parametric model \hat{ƒ}₁ 1520 is obtained as described above with reference to Equations (11) and (12) using the folds (X̅₂, Y̅₂), (X̅₃, Y̅₃), (X̅₄, Y̅₄), and (X̅₅, Y̅₅) as a training set. The trained model \hat{ƒ}₁ is applied to the metric X̅₁ to obtain an estimated KPI Ŷ₁ 1522. A mean square error MSE(Ŷ₁, Y̅₁) 1524 is computed for the estimated KPI Ŷ₁ and the KPI Y̅₁ of the first fold. For the second iteration in FIG. 15B, the second fold (X̅₂, Y̅₂) is the validating set and a model \hat{ƒ}₂ 1526 is trained as described above with reference to Equations (11) and (12) using the folds (X̅₁, Y̅₁), (X̅₃, Y̅₃), (X̅₄, Y̅₄), and (X̅₅, Y̅₅) as a training set. The trained model \hat{ƒ}₂ is applied to the metric X̅₂ to obtain an estimated KPI Ŷ₂ 1528. A mean square error MSE(Ŷ₂, Y̅₂) 1530 is computed for the estimated KPI Ŷ₂ and the KPI Y̅₂ of the second fold. In FIGS. 15C-15E, the same process is repeated where each of the folds (X̅₃, Y̅₃), (X̅₄, Y̅₄), and (X̅₅, Y̅₅) is used separately as a validating set to obtain corresponding parametric models \hat{ƒ}₃, \hat{ƒ}₄, and \hat{ƒ}₅ and corresponding mean square errors MSE(Ŷ₃, Y̅₃), MSE(Ŷ₄, Y̅₄), and MSE(Ŷ₅, Y̅₅). A 5-fold cross-validation estimate, CV₅, is computed as described above with reference Equation (18b). If the 5-fold cross-validation estimate satisfies the condition in Equation (18c), a trained parametric model is computed with estimated model coefficients computed as described above with reference to Equation (18d).

In another implementation, ridge regression may be used to compute estimated model coefficients {\hat{β}ⱼ^{R}}ⱼ₌₁^{N} that minimizes

$$\{ {\hat{β}}_{j}^{R} {\}}_{j = 1}^{N} = {{\sum }^{M}}_{m = 1} {( {y}_{m} - {β}_{0} - {\sum }_{j = 1}^{N} {β}_{j} {x}_{m j} )}^{2} \qquad ( 19 a )$$

subject to the constraint that

$${\sum }_{j = 1}^{N} {β}_{j}^{2} \leq λ \qquad ( 19 b )$$

where λ≥0 is a tuning parameter that controls the relative impact of the coefficients. The estimated model coefficients are computed using least squares with

\hat{β}^{R}=(X^{T}X+λl_{N×N})⁻¹X^{T}Y (20)

where l_{N×N} is the N×N identity matrix for different values of the tuning parameter λ. A set of metrics and a KPI recorded over a time window are partitioned to form a training set and a validating set as described above with reference to FIG. 15A. A set of parametric models, {\hat{ƒ}⁽⁸⁰⁾}, are computed for different tuning parameters according to Equation (19a)-(19b). The parametric models are used to compute a set of corresponding estimated KPIs {Ŷ^{(λ)}} for each of the tuning parameters. The parametric model that gives the smallest SSR value computed according to Equation (16) is the trained parametric inference model.

In still another implementation, lasso regression may be used to compute estimated model coefficients {\hat{β}ⱼ^{L}}ⱼ₌₁^{N} that minimizes

$${\{ {\hat{β}}_{j}^{L} \}}_{j = 1}^{N} = arg min \{ {\sum }_{m = 1}^{M} {( {y}_{m} - {β}_{0} - {\sum }_{j = 1}^{N} {β}_{j} {x}_{mj} )}^{2} \} \qquad ( 21 a )$$

subject to the constraint that

$${{\sum }_{j = 1}}^{M} \vert {β}_{j} \vert \leq s \qquad ( 21 b )$$

where s≥0 is a tuning parameter. Computation of the estimated model coefficients {\hat{β}ⱼ^{L}}ⱼ₌₁^{N} is a quadratic programming problem with linear inequality constraints as described in “Regression Shrinkage and Selection via the Lasso,” by Robert Tibshirani, J. R. Statist. Soc. B (1996) vol. 58, no. 1, pp. 267-288.

The parametric inference models described above are computed based on an assumed linear relationship between event-type probabilities of relevant event types and a KPI. However, in certain cases, the relationship between event-type probabilities and a KPI is not linear. A cross-validation error estimate, denoted by CVₑᵣᵣₒᵣ, may be used to determine whether a parametric inference model is suitable or a non-parametric inference model should be used instead. When the cross-validation error estimate satisfies the condition CVₑᵣᵣₒᵣ<Thₑᵣᵣₒᵣ, where Thₑᵣᵣₒᵣ is an error threshold (e.g., Thₑᵣᵣₒᵣ=0.1 or 0.2), the parametric inference model is used. Otherwise, when the cross-validation error estimate satisfies the condition CVₑᵣᵣₒᵣ≥Thₑᵣᵣₒᵣ, a non-parametric inference model is computed as described below. For the k-fold cross validation, the CVₑᵣᵣₒᵣ=CVₖ, described above with reference to Equation (18b). For the other parametric inference models described above, the CVₑᵣᵣₒᵣ=MSE(Ŷ, Y^{V}), where Ŷ is the estimated KPI computed for a validating set of metrics X^{V} and validating KPI Y^{V}.

In cases where there is no linear relationship between metrics and a KPI, the analytics engine 312 trains a non-parametric inference model based on K-nearest neighbor regression. K-nearest neighbor regression is performed by first determining an optimum positive integer number, K, of nearest neighbors for the metrics and the KPI. The optimum K is then used to predict, or forecast, a KPI value for prospective changes to metric values of the metrics and troubleshoot a root cause of an application performance problem.

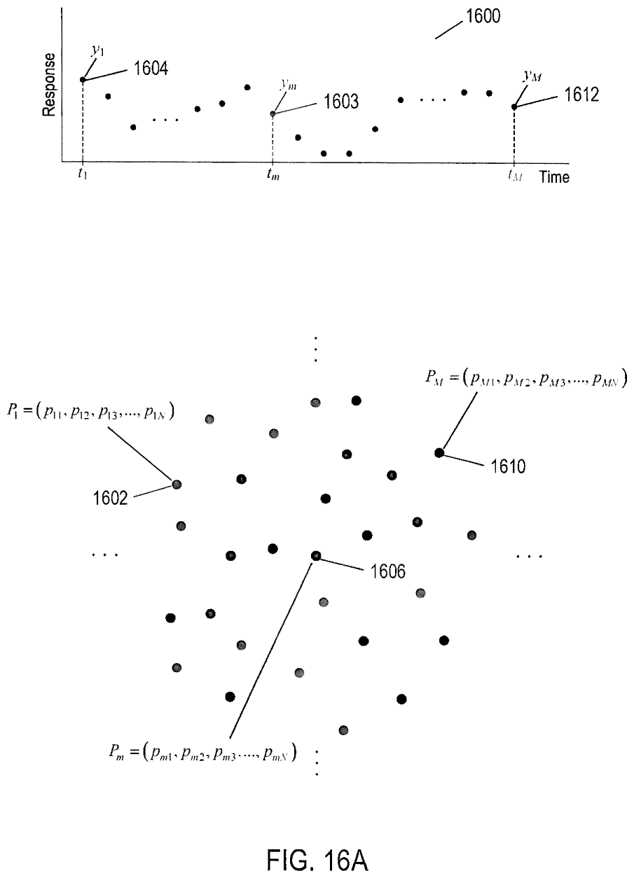

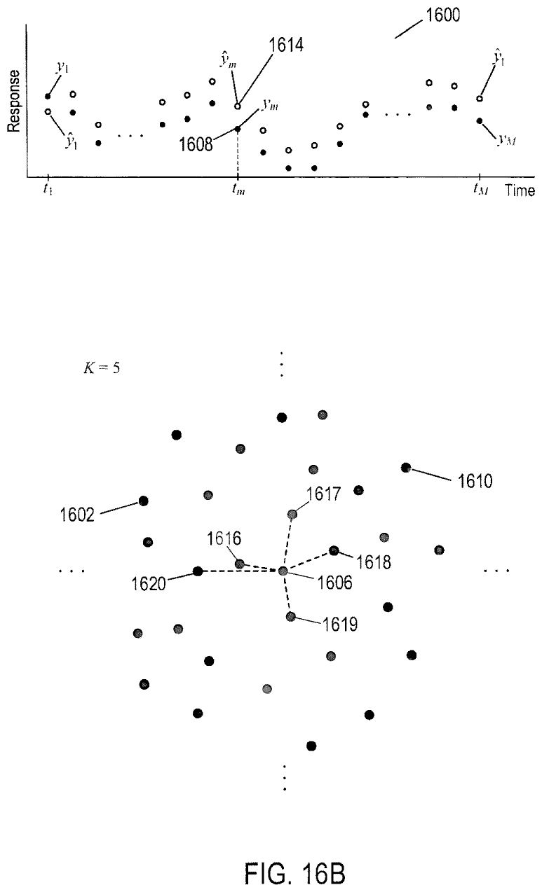

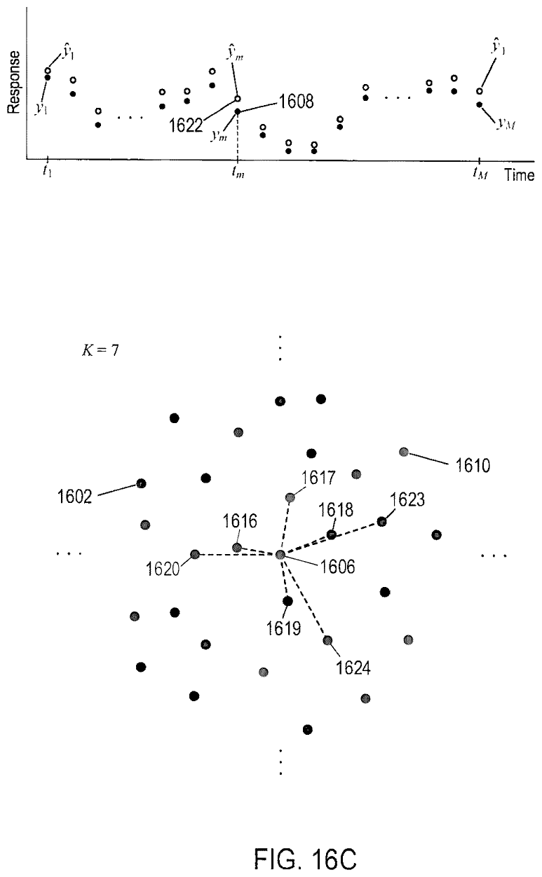

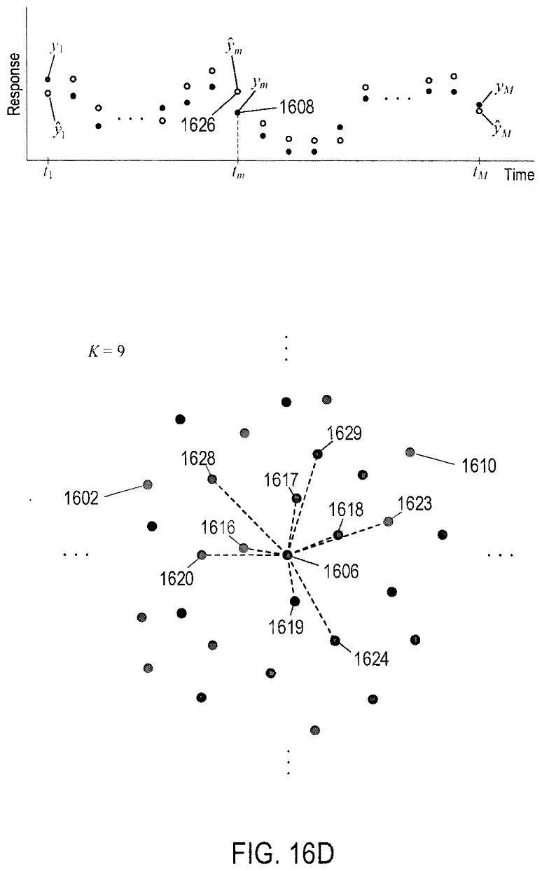

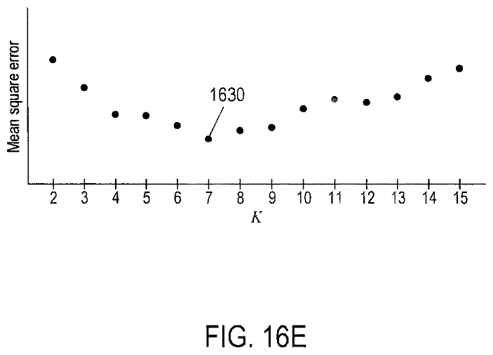

FIGS. 16A-16E show an example of determining a K-nearest neighbor regression model. FIG. 16A shows an example of N-tuples (i.e., probability distributions) of N event-type distributions represented by points in a N-dimensional space and a plot 1600 of corresponding KPI values of a KPI. Each N-tuple of the N event-type probabilities is represented by a point in a N-dimensional space and has a corresponding KPI value in the plot 1600 at the same time stamp. For example, point 1602 comprises metrics values of N event-type probabilities and corresponds to KPI value 1604 at a time stamp t₁. Point 1606 comprises event-type probabilities of the N event-type probabilities and corresponds to KPI value 1608 at a time stamp tₘ. Point 1610 comprises event-type probabilities of the N event types and corresponds to KPI value 1612 at a time stamp t_{M}.

A distance is computed between each pair of the N-tuples in the N-dimensional space using a Euclidean distance:

d(P_{α}, Pₘ)=\sqrt{(p_{α1}−pₘ₁)²+ . . . +(p_{αN}−p_{mN})²}

where m=1, . . . , M with m≠α.
Let N_{K} denote a set of K nearest-neighbor N-tuples to a probability distribution Pₘ. For an initial value K (e.g., K=2), an estimated KPI is computed by averaging KPI values of K nearest-neighbor N-tuples to the N-tuple Pₘ of each time stamp tₘ in the time window:

$${\hat{y}}_{m} = \frac{1}{K} {\sum }_{{p}_{α} ∈ {N}_{K}} {y}_{α} \qquad ( 22 )$$

The process is repeated for different values of K. An MSE is computed for each K as follows:

$$M S E ( K ) = \frac{1}{M} {\sum }_{m = 1}^{M} {( {y}_{m} - {\hat{y}}_{m} )}^{2} \qquad ( 23 )$$

The value of K with the minimum MSE is the optimum K that relates the metrics to the KPI. Let N₀ be the K N-tuples that are closest to a N-tuple P. The estimate KPI is given by:

$${\hat{y}}_{0} = \hat{f} ( {P}_{0} ) = \frac{1}{K} {\sum }_{{p}_{α} ∈ {N}_{0}} {y}_{α}$$

FIG. 16B shows an example of computing an estimated KPI for K=5 nearest neighbors to each N-tuple. The estimated KPI values computed for the five nearest neighbors of the N-tuples are represented open dots in the plot 1600. For example, estimated KPI value ŷₘ 1614 is computed by averaging the KPI values of the five nearest N-tuples 1616-1620 of the N-tuple 1606 according to Equation (22). An MSE, MSE(5), is computed for the estimated KPI values and KPI values according to Equation (23).

FIG. 16C shows an example of computing estimated KPI for K=7 nearest neighbors to each N-tuple. The estimated KPI values computed for seven nearest neighbors of the N-tuples are represented by open dots in the plot 1600. For example, estimated KPI value ŷₘ 1622 is computed by averaging the KPI values of the seven nearest N-tuples 1616-1620 and 1623-1624 of the N-tuple 1606 according to Equation (22). An MSE, MSE(7), is computed for the estimated KPI values and KPI values according to Equation (23).

FIG. 16D shows an example of computing estimated KPI for K=9 nearest neighbors to each N-tuple. The estimated KPI values computed for nine nearest neighbors of the N-tuples are represented by open dots in the plot 1600. For example, estimated KPI value ŷₘ 1626 is computed by averaging the KPI values of the nine nearest N-tuples 1616-1620, 1623, 1624, 1628, and 1629 of the N-tuple 1606 according to Equation (22). An MSE, MSE(9), is computed for the estimated KPI values and KPI values according to Equation (23).

FIG. 16E shows a plot of MSE values versus values of K. Dots represent MSE values for K ranging from 2 to 15. In this example, the minimum MSE 1630 occurs at K=7. As a result, the optimum K that relates the event-type probabilities to the KPI shown in in FIG. 16A is K=7. In this example, a predicted KPI for an unknown N-tuple is computed by averaging seven KPI values of the seven metrics located closest to the unknown N-tuple in N-dimensional space.

Certain event types may not reveal useful information about the root cause of a problem. In FIG. 3, the analytics engine 312 sends the event types and corresponding log messages to the user interface 302. The user interface 302 produces a graphical user interface (“GUI”) in a display device, such as the console of a system administrator. The GUI displays the event types and corresponding log messages. The GUI includes fields that enable a user to view the log messages associated with the event types and select which of the event types reveal useful information about the probable root cause of a problem and discard event types that do not.

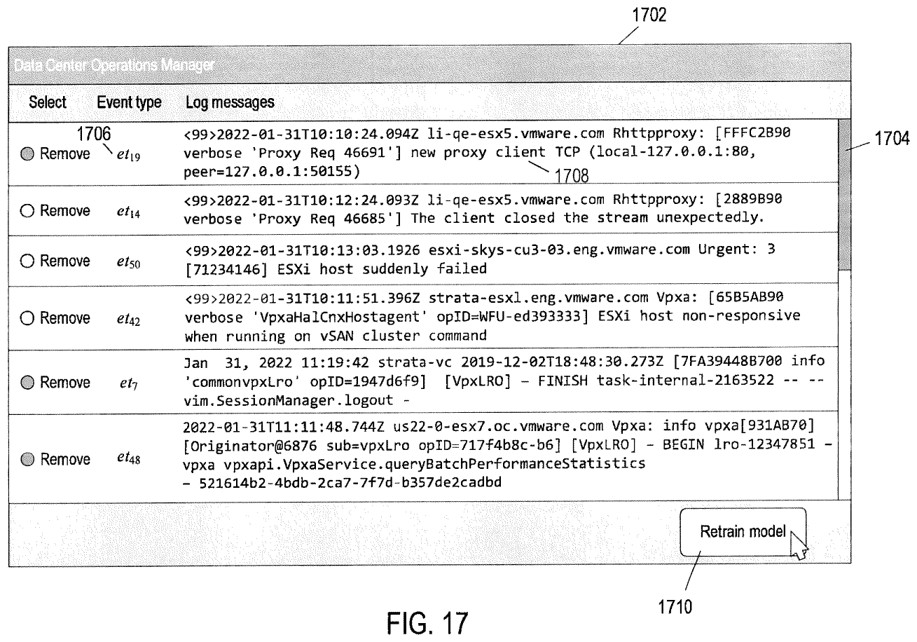

FIG. 17 shows an example GUI 1702 that displays the event types and corresponding most recently generated log messages. A user can use the scroll bar 1704 to scroll up and down to view other event types and log messages not shown. For example, event type et₁₉ 1706 represents corresponding log message 1708. In this example, the left-hand column of the GUI 1702 enables a user select event types for removal. For example, the log messages of the event types et₁₉, et₇, and et₄₈ do not contain descriptions of problems or are not associated with problems. By contrast, event types et₁₄, et₅₀, and et₄₂ describe problems. For example, the log message of event type et₁₄ describes a problem created by a client closing the stream unexpectedly, the log message of the event type et₅₀ describes a problem created by an ESXi host that suddenly failed, and the log message of the event type et₄₂ describes a problem created by an ESXi host that is non-responsive. As shown in FIG. 17, the GUI 1702 enables a user to select event types that do not describe probable root causes of a problem to be removed. The user can then select retraining the inference model by clicking on button 1710 using the event-type probabilities of the unselected event types.

Application performance problems can originate from the infrastructure and/or the application itself and can be discovered in an application KPI. For example, an application with a KPI that violates a performance threshold can be selected for troubleshooting. After an inference model has been trained for the application, the computer-implemented processes and systems described below use the trained inference model to determine importance scores of event types to be used for diagnosis application performance problems and application tunning purposes. The processes and systems eliminate human errors in detecting application performance problems and significantly reduce the time for detecting the performance problem from days and weeks to minutes and seconds. The processes and systems provide immediate notification of a performance problem, provide a recommendation for correcting the performance problem, and enable rapid execution of remedial measures that correct the performance problem.

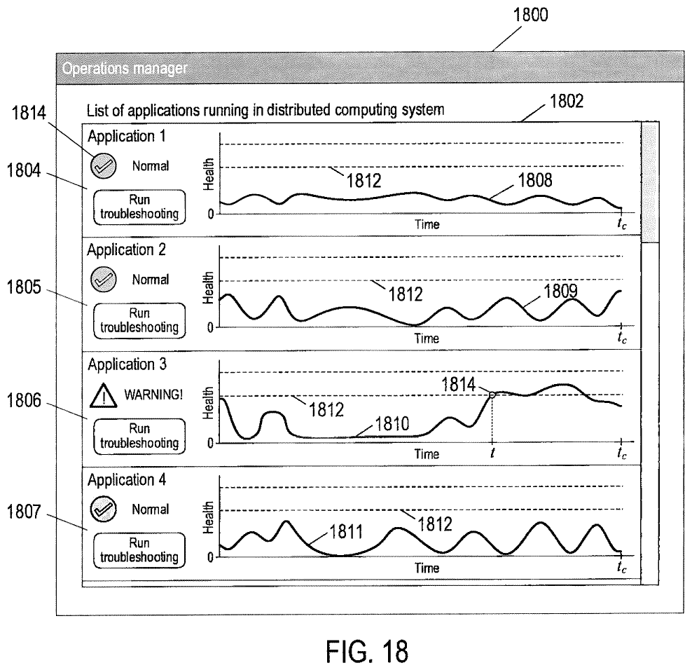

FIG. 18 shows an example graphical user interface (“GUI”) 1800 that displays KPIs associated with different applications running in a distributed computing system. The GUI 1800 includes a window 1802 that displays four entries 1804-1807 that list applications identified as Application 1, Application 2, Application 3, and Application 4 and show plots of curves 1808-1811 that represent corresponding KPIs plotted over the same recent run-time interval that ends at the current time denoted by t_{c}. Horizontal dashed lines represent thresholds between normal and abnormal behavior of the applications. For example, KPI values of Applications 1, 2, and 4 are below a threshold 1812, which indicates the applications are performing normally as represented by normal icons, such as normal icon 1814. On the other hand, KPI values of the Application 3 exceed the threshold 1812, such as KPI value 1814, triggering a warning alert 1816. Threshold 1816 indicates the application exhibits critical behavior that triggers a critical alert icon that is not shown. A user may select “run troubleshooting” by clicking on the button 1818, which begins the automated computer-implemented process of troubleshooting Application 3 described below.

Each KPI of an application running in distributed computing system as an associated trained inference model denoted by \hat{ƒ}^{t}. When troubleshooting is executed for an application running in a distributed computing system, the analytics manager 312 uses the trained inference model \hat{ƒ}^{t} associated with the KPI exhibiting the performance problem to troubleshoot the performance problem. The analytics engine 312 retrieves log messages generated in a run-time interval denoted by [t_{b}, t_{c}] from the log database 315, where t_{b} denotes the beginning of the run-time interval, and t_{c} (i.e., current time) denotes the end of the run-time interval, For example, the run-time interval [t_{b}, t_{c}] may have a duration of 30 seconds, 1 minute, 2 minutes, or 10 minutes. The event type engine 306 determines event types of the log messages in the run-time interval. The analytics engine 312 computes run-time event-type probability distributions for KPI values of the KPI in the run-time interval [t_{b}, t_{c}]:

Pᵣ=(pᵣ₁, pᵣ₂, . . . , p_{r,N-1}, p_{rN}) (24)

where
subscript r is run-time index r=1, . . . , R;
R is the number of KPI values in the run-time interval [t_{b}, t_{c}]; and

$${p}_{r n} = \frac{n ( e {t}_{r n} )}{N} \qquad ( 25 )$$

The run-time event-type probabilities are used to form the run-time event-type probabilities {Xⱼ^{r}}ⱼ₌₁^{N}. The run-time KPI values are normalized and denoted by Y^{r}.

The analytics engine 312 uses the trained inference model (i.e., parametric inference model or non-parametric inference model) \hat{ƒ}^{t} to identify the event types that are associated with the performance problem identified in the KPI. In one implementation, a run-time estimated KPI, Ŷₘ^{r}, is computed for each event-type probability Xₘ^{r} by omitting the event-type probability Xₘ^{r}, from the trained inference model. For example, for each m=1, . . . , N, the analytics engine 312 computes a run-time estimated KPI using the trained inference model:

\hat{ƒ}^{t}({Xⱼ^{r}}ⱼ₌₁^{p}−Xₘ^{r})=Ŷₘ^{r} (26)

where
the minus symbol “−” denotes subtraction, or omission, of the event-type probabilities Xₘ^{r} from the set of run-time event type probabilities {Xⱼ^{r}}ⱼ₌₁^{p} to obtain a set of expected run-time KPIs {Ŷₘ^{r}}ₘ₌₁^{N}; and
\hat{ƒ}^{t}(·) denotes the trained inference model.
   An MSE, MSE(Ŷₘ^{r}, Y^{r}), is computed for each of the expected run-time KPIs {Ŷₘ^{r}}ₘ₌₁^{N}. Each MSE indicates the degrees to which the KPI depends on an event type. An omitted event-type distribution with a large associated MSE indicates that the KPI depends on the omitted event type more than an omitted event type with a smaller MSE. The analytics engine 312 computes an importance score for each event type based on the associated MSE. The importance score is a measure of how much the KPI depends on the metric. The operations manager computes the importance score for each event type by first determining the largest MSE of the N run-time event-type probabilities:

MSEₘₐₓ=max{MSE(Ŷ₁^{r}, Y^{r}), . . . , MSE(Ŷ_{N}^{r}, Y^{r})} (27)

The analytics engine 312 then computes an importance score for each j=1, . . . , N as follows:

$${I}_{j}^{score} = \frac{M S E ( {\hat{Y}}_{j}^{r} , {Y}^{r} )}{M S {E}_{max}} ⨯ 100 \qquad ( 28 )$$

A threshold for identifying the highest ranked event type is given by the condition:

Iⱼ^{score}>Th_{score} (29)

where Th_{score} is a user defined threshold. For example, the user-defined threshold may be set to 70%, 60%, 50% or 40%. The importance score computed in Equation (28) is assigned to each corresponding event type. The event types are rank ordered based on the corresponding importance scores to identify the highest ranked event types that affect the KPI. For example, the highest ranked event types have importance scores above the user-defined threshold Th_{score}. The combination of highest ranked event types associated with a KPI that indicates a performance problem with an application identify the root cause of the performance problem with the application.

In another implementation, importance scores of the event types are determined based on magnitudes of the estimated model coefficients of a parametric inference model. The magnitudes of the estimated model coefficients are given by |\hat{β}ⱼ|, where |·| denotes the absolute value and j=1, . . . , N. The operations manager computes the importance score for each event type by first determining the largest magnitude estimated model coefficient:

\hat{β}ₘₐₓ=max{|\hat{β}₁|, . . . , |\hat{β}_{N}|} (30)

The operations manager then computes an importance score for each j=1, . . . , N as follows:

$${I}_{j}^{score} = \frac{\vert {\hat{β}}_{j} \vert}{{\hat{β}}_{max}} ⨯ 100 \qquad ( 31 )$$

An importance score is assigned to each corresponding event type etⱼ. The event types are rank ordered based on the corresponding importance scores to identify the highest ranked event types that affect the KPI using the condition in Equation (29).

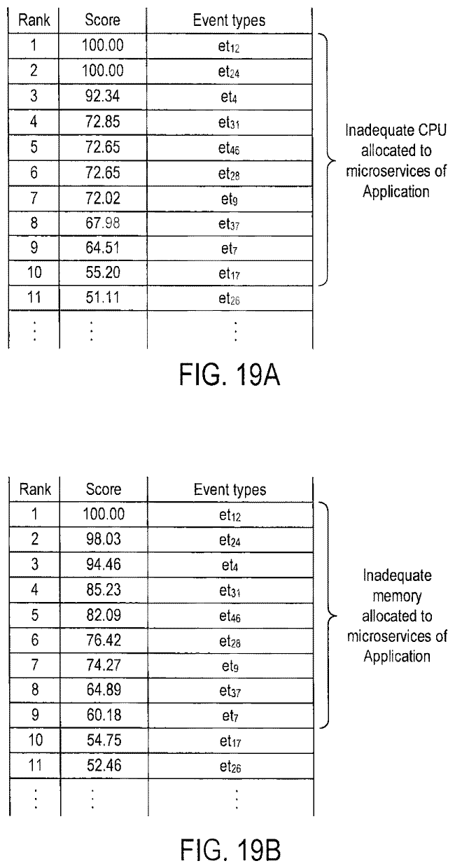

FIGS. 19A-19B show examples of highest ranked event types associated with different types of performance problems. FIG. 19A shows an example of event types, importance scores and ranks of event types with importance scores above 55%. The combination of event types with importance scores greater than 55 are associated with inadequate CPU allocated to microservices of an application. FIG. 19B shows an example of event types, importance scores and ranks of event types with importance scores above 60% and are associated with inadequate memory allocated to microservices of an application.

In one implementation, the analytics engine 312 compares the highest ranked event types with different lists of ranked even types. Each list of ranked event types corresponds to a particular performance problem and has an associated recommended remedial measure for correcting the performance problem. When a match between the highest ranked event types and a list of ranked event types is determined, the performance problem that corresponds to the list of ranked event types is identified as the performance problem of the application.

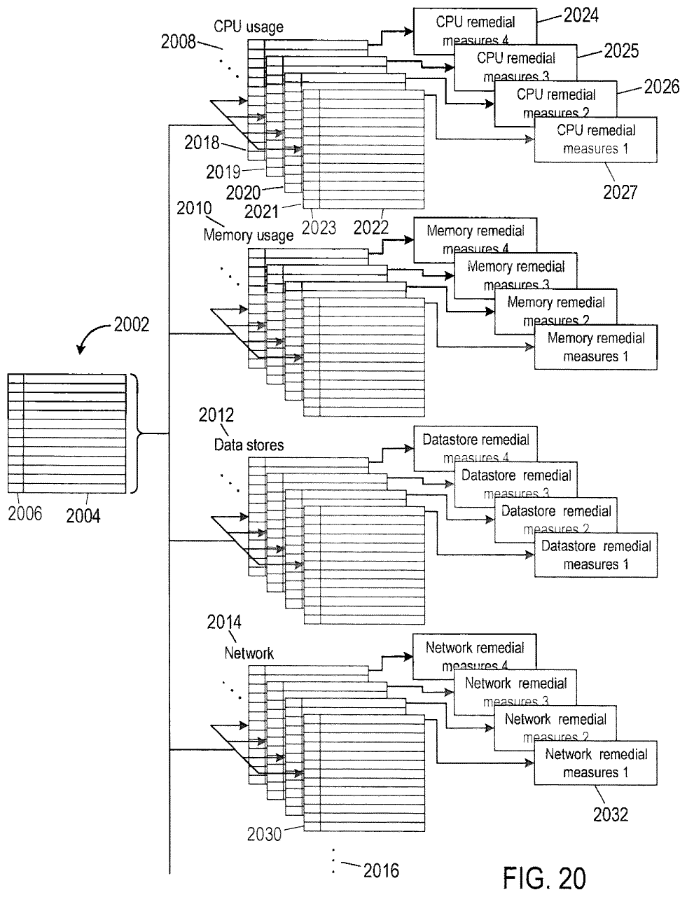

FIG. 20 shows an example of highest ranked run-time event types 2002, such as one of the highest ranked run-time event types shown in FIGS. 19A-19B. The highest ranked event types 2002 include a column 2004 of event types and a column 2006 of associated ranks, such as the columns of event types and associated ranks described above with reference to FIGS. 19A-19B. The analytics engine 312 maintains in a data-storage device lists of ranked even types associated with CPU usage 2008, memory usage 2010, data stores 2012, network throughput 2014, and other lists of ranked even types represented by ellipsis 2016, such as traffic rate, traffic drop rate, and flow rate. For example, CPU usage performance problems has lists of ranked event types 2018-2021. Each listing contains a different combination of event types and associated ranks and is associated with a particular application performance problem. For example, list of ranked event types 2021 includes a column 2022 of event types and a column 2023 of associated ranks. Each list of ranked event types has an associated rule that when executed by the analytics engine 312 identifies the performance problem associated with the list of ranked event types. For example, lists of ranked event types 2018-2021 have different corresponding rules 2024-2027 that identify the performance problem associated with the lists of ranked event types 2018-2021. Examples of performance problems associated with different combinations of ranked event types in the lists of ranked event types maintained by the operations manager include, but are not limited to, CPU usage overload on VM of the application, CPU usage overload of host, memory overload on a host of application VMs, virtual CPU overload for a VM, virtual memory usage overload for a VM, virtual router overloaded, packet drops occurring at VM, packet drops occurring at a firewall, sudden traffic burst at VM, traffic rate at a VM suddenly drops, a data link between hosts has failed. The operations manager compares the highest ranked event types 2002 with each list. When the ranked order of event types in the highest ranked event types 2002 matches the ranked order of event types in one of the lists of ranked event types, the corresponding rule reports the performance problem in a GUI the form of an alert that identifies the performance problem and a recommendation for correcting the performance problem.

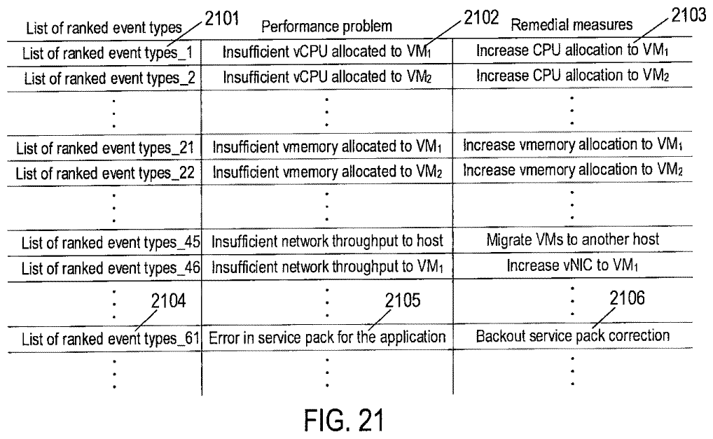

FIG. 21 shows a table of example rules stored in a data storage device and is accessed by the analytics engine 312 to report performance problems and recommend remedial measures for correcting the performance problem. When the highest ranked metrics 2002 matches list of metrics “List of ranked metrics_1” 2101, the analytics engines displays the performance problem “insufficient vCPU allocated to VM₁” 2102 and a recommendation “increase CPU allocation to VW₁” 2103 in a GUI. When the highest ranked metrics 2002 matches list of metrics “List of ranked metrics_61” 2104, the analytics engine 312 displays the performance problem “error in service pack for the application” 2105 and a recommendation “backout service pack correction” 2106 in a GUI.

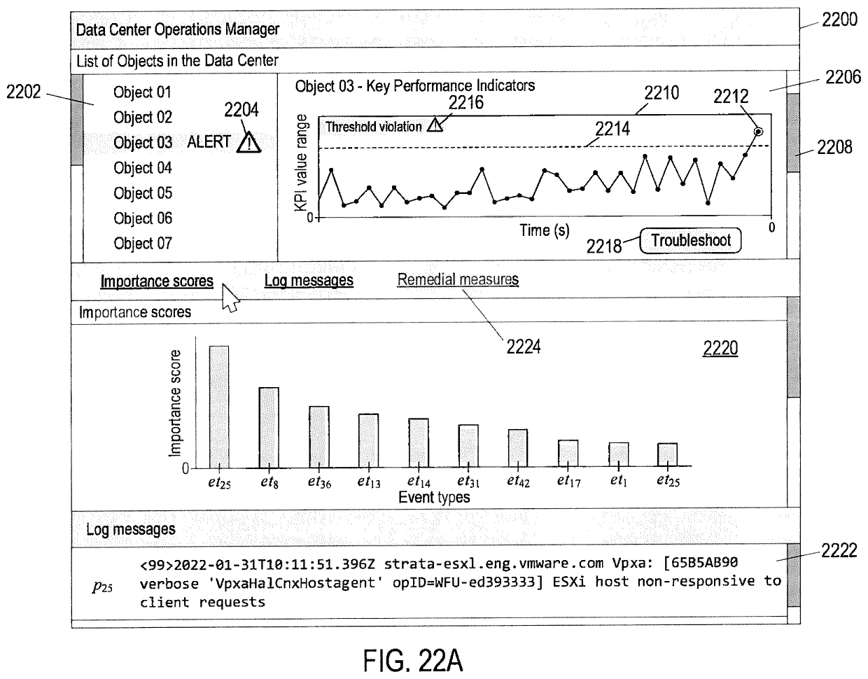

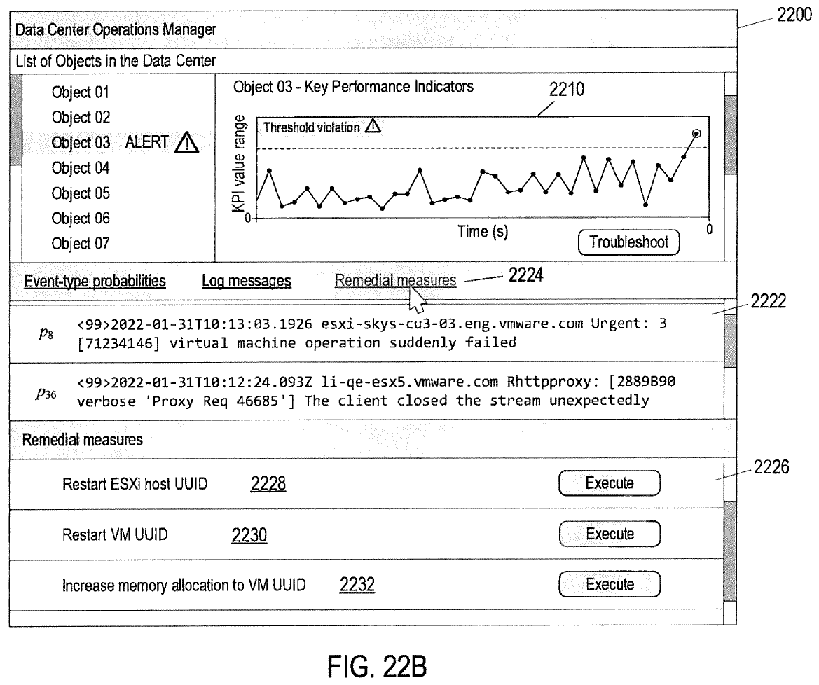

FIG. 22A shows an example GUI 2200 that displays a list of objects executing in a data center in a left-hand pane 2202. Each object may have numerous KPIs that are used to monitor different aspects of the performance of the object as described above. In this example, the object identified as “Object 03” has an associated alert 2204. A user may click on the highlighted area around Object 03, creating plots of the KPIs associated with Object 03 in a right-hand pane 2206. In this example, a user has used the scroll bar 2208 to scroll to a plot 2210 of a KPI exhibiting the alert that corresponds to a KPI value 2212 that violates a KPI threshold 2214. In this example, an alert 2216 is displayed in the plot 2210. Each KPI has an associated troubleshoot button. In this example, a user clicks on the troubleshoot button 2218 to start the troubleshooting process of the KPI. In response to receiving the troubleshoot command from the user interface 302, the analytics engine 312 executes the operations to obtain log messages that describe the probable root cause of the performance problem indicated by the KPI threshold violation. The GUI 2200 includes a pane 2220 that displays a plot of the ten largest importance scores of the event types of log messages produced in a time interval as described above with reference to Equations (24) . . . (29). Pane 2222 displays the most recent log messages of the ten largest importance scores. A user can scroll through the log messages and identify the log messages that describe the root cause of the problem. The user clicks on the “remedial measures” button 2224 to display remedial measures associated with the root cause of the problem.

FIG. 22B shows a remedial measures pane 2226 displayed in the GUI 2200 in response to a user clicking on the “remedial measures” button 2224. Remedial measures include restarting the host 2228, restarting the VM 2230, and increasing memory allocation to the VM 2232, where UUID denotes the universal unique identity of the object. A user can automatically execute a selected remedial measure by clicking on the corresponding “Execute” button. Other remedial measures that may be executed to correct the problem with the object include, but are not limited to, powering down hosts, replacing VMs disabled by physical hardware problems and failures, spinning up cloned VMs on additional hosts to ensure that the microservices provided by the VMs are accessible to increasing demand for services. When an alert is generated indicating inadequate virtual processor capacity, remedial measures that increase the virtual processor capacity of the virtual object may be executed, the virtual object may be deleted, or the virtual object may be migrated to a different server computer with more processor capacity.

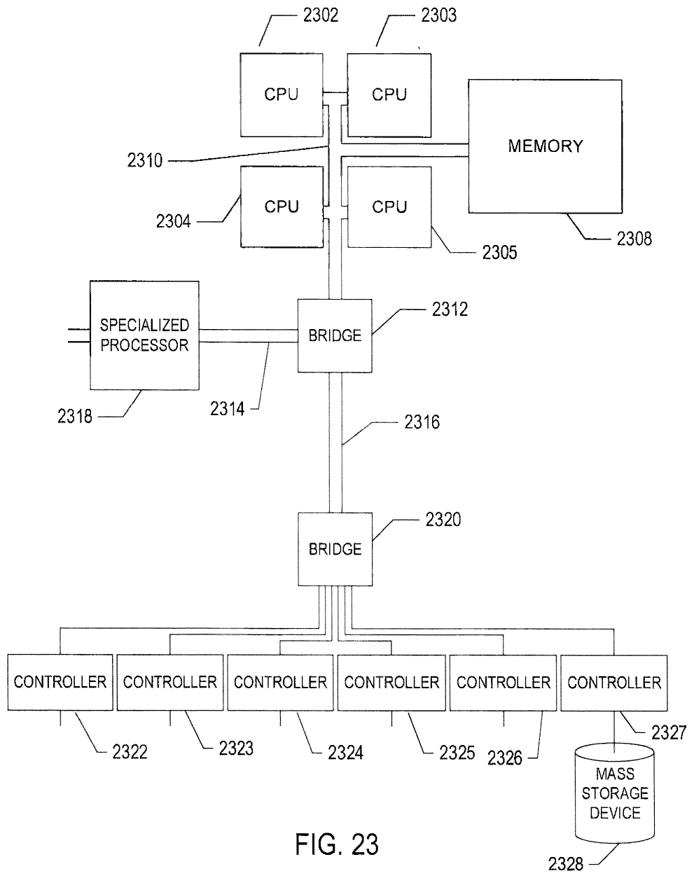

FIG. 23 shows an example architecture of a computer system that may be used to host the operations manager 132 and perform the automated processes for troubleshooting and resolving performance problems with objects executing in a data center. The computer system contains one or multiple central processing units (“CPUs”) 2302-2305, one or more electronic memories 2308 interconnected with the CPUs by a CPU/memory-subsystem bus 2310 or multiple busses, a first bridge 2312 that interconnects the CPU/memory-subsystem bus 2310 with additional busses 2314 and 2316, or other types of high-speed interconnection media, including multiple, high-speed serial interconnects. The busses or serial interconnections, in turn, connect the CPUs and memory with specialized processors, such as a graphics processor 2318, and with one or more additional bridges 2320, which are interconnected with high-speed serial links or with multiple controllers 2322-2327, such as controller 2327, that provide access to various different types of computer-readable media, such as computer-readable medium 2328, electronic display devices. input devices, and other such components, subcomponents, and computational resources. The electronic displays, including visual display screen, audio speakers, and other output interfaces, and the input devices, including mice, keyboards, touch screens, and other such input interfaces, together constitute input and output interfaces that allow the computer system to interact with human users. Computer-readable medium 2328 is a data-storage device, which may include, for example, electronic memory, optical or magnetic disk drive, a magnetic tape drive, USB drive, flash memory and any other such data-storage device or devices. The computer-readable medium 2328 is used to store machine-readable instructions that encode the computational methods of the operations manager 132.

The automated computer-implemented processes described herein provide a number of advantages over existing techniques used by typical operation management tools. For example, the processes described herein eliminate human errors in detecting probable root causes of a performance problem of an object executing in a data center. The processes significantly reduce the amount time spent detecting probable root causes over typical operation management tools. The time reduction may be from days and weeks to minutes and seconds, thereby providing immediate notification of a performance problem, providing at least one probable root cause, thereby enabling rapid execution of remedial measures that correct the problem.

In another implementation, the inference models can be used to identify log messages of event types that impact performance of data center objects in order to optimize planning and avoid performance problems with objects. For example, a system administrator may observe via the graphical user interface that a KPI has not violated a KPI threshold, but KPI values have not stayed in a desired range of values. For example, the KPI may be latency metric of an object, such as Object 02 in the GUI 2200. Suppose a systems administrator observes that the KPI has not violated a corresponding latency threshold in pane 2206, but the KPI often indicates an increase in network latency for periods that are longer than expected. The KPI has an associated inference model as described above. Even though the KPI has not violate a KPI threshold, the systems administrator may click on the troubleshoot button 2218 to view event types with the largest importance scores and log messages associated with the event types in panes 2220 and 2222, respectively. As a result, the systems administrator can view log messages of negatively impacting event types and positively impacting event types. Having the log messages of the most important event types (i.e., event types with highest importance scores), the systems administrator can view the log messages and execute appropriate measures that adjust performance of the object. For example, consider the network latency KPI. The operations manager 132 displays log messages of event types with the highest importance scores in the pane 2222 associated with the network latency KPI. These log messages may reveal that various objects that are geographically distributed are the cause of the network latency. The systems administrator may attempt to reduce the latency by spinning up these same objects in the data center in order to avoid long distance communications.

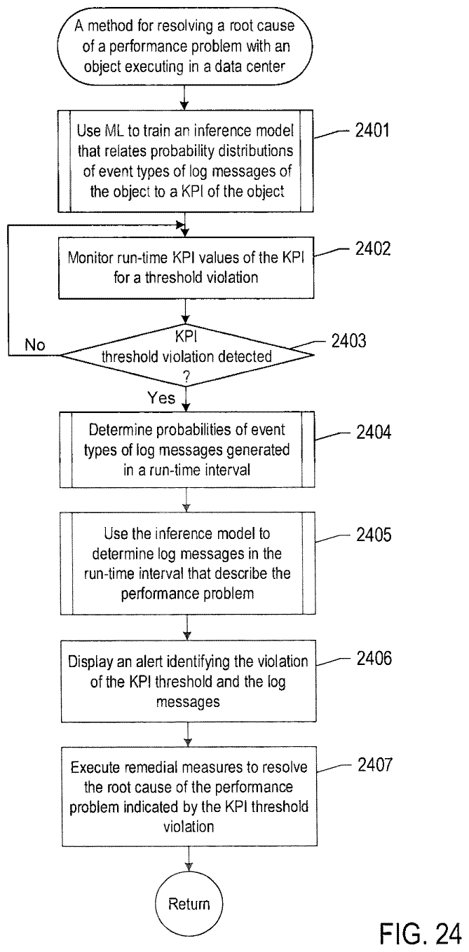

The methods described below with reference to FIGS. 24-28 are stored in one or more data-storage devices as machine-readable instructions that when executed by one or more processors of a computer system, such as the computer system shown in FIG. 23, that resolves the root causes of a performance problem with an object executing in a data center.

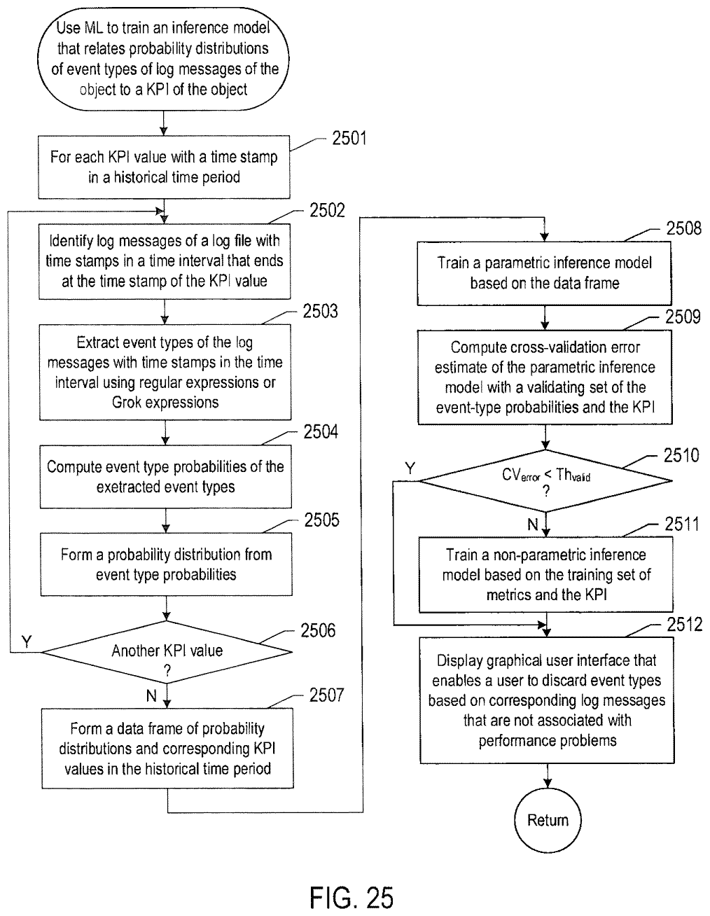

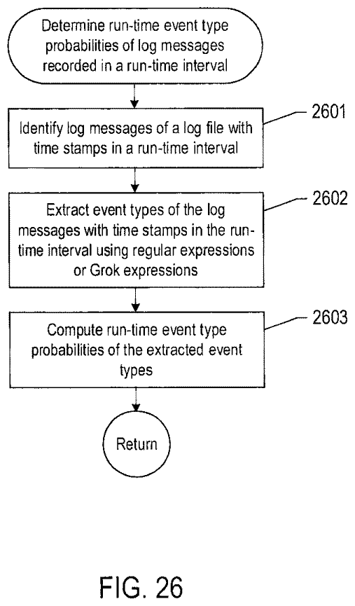

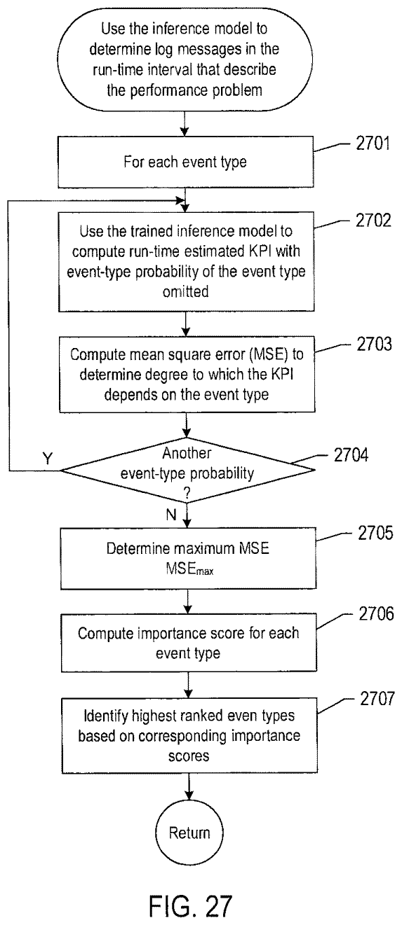

FIG. 24 is a flow diagram illustrating an example implementation of a method for resolving a root cause of a performance problem with an object executing in a data center. In block 2401, a “use machine learning (“MU”) to train an inference model that relates probability distributions of event types of log messages of the object to a KPI of the object” procedure is performed. An example implementation of the “use machine learning (“ML”) to train an inference model that relates probability distributions of event types of log messages of the object to a KPI of the object” process is described below with reference to FIG. 25. In block 2402, run-time KPI values of the KPI are monitored for KPI threshold violations. In decision block 2403, in response to a run-time KPI value violating the KPI threshold in block 2402, control flows to block 2404. In block 2404, a “determine probabilities of event types of log messages generated in the run-time interval” procedure is performed. An example implementation of the “determine probabilities of event types of log messages generated in the run-time interval” is described below with reference to FIG. 26. In block 2405, a “use the inference model to determine log messages in the run-time interval that describe the performance problem” procedure is performed. An example implementation of the “use the inference model to determine log messages in the run-time interval that describe the performance problem” is described below with reference to FIG. 27. The log messages that describe the performance problem reveal the root cause of the performance problem. In block 2406, an alert identifying the violation of the KPI threshold and the log messages are displayed in a graphical user interface of an electronic display device as described above with reference to FIGS. 22A-22B. The log messages describe the probable root cause of the performance problem. In block 2407, remedial measures to resolve the performance problem associated with the KPI threshold violation detected in block 2403 are executed. The remedial measures include, but are not limited to, restarting a host that runs the object, restarting the object, increasing memory or CPU allocation to the object. Other remedial measures include deleting the object and migrating the object to a different host.

FIG. 25 is a flow diagram illustrating an example implementation of the “use machine learning (“ML”) to train an inference model that relates probability distributions of event types of log messages of the object to a KPI of the object” procedure performed in block 2401 of FIG. 24. A loop beginning with block 2501 repeats the computational operations represented by blocks 2502-2506 for each KPI value in a time period. In decision block 2502, log messages of a log file with time stamps in a time interval that ends with the time stamp of the KPI value are identified as described above with reference to FIG. 11. In block 2502, event types of the log messages with time stamps in the time interval are extracted as described above with reference to FIGS. 9A-9C. In block 2504, event-type probabilities of the extracted event types are computed as described above with reference to Equation (5). In block 2505, a probability distribution is formed as described above with reference to Equation (6). In decision block 2506, if another KPI value is available in the time period, control flows to decision block 2502. Otherwise control flows to block 2507. In block 2507, a data frame is formed from the probability distributions and corresponding KPI values of the KPI in the time period. In block 2508, a parametric model is trained based on the probability distributions and corresponding KPI values in the data frame. In block 2509, a cross-validation error estimate of the parametric inference model with a validating set of the event-type probabilities and the KPI. In decision block 2510, when the cross-validation error is less than an error threshold, control flows to block 2512. Otherwise, control flows to block 2511. In block 2512, a graphical user interface is displayed that enables a user to select event types based on corresponding log messages that are associated with performance problems as described above with reference to FIG. 17.

FIG. 26 is a flow diagram illustrating an example implementation of the “determine probabilities of event types of log messages generated in the run-time interval” procedure performed in block 2404 of FIG. 24. In block 2601, log messages or a log file with time stamps in a run-time interval with the KPI value that violates the KPK threshold are identified. In block 2602, event types of the log messages identified in block 2601 are extracted. In block 2603, run-time event-type probabilities of the extracted event types are computed as described above with reference to Equations (24) and (25).

FIG. 27 is a flow diagram illustrating an example implementation of the “use the inference model to determine log messages in the run-time interval that describe the performance problem” procedure performed in block 2405 of FIG. 24. A loop beginning with block 2701 repeats the computational operations represented by blocks 2702-2704 for each event type of the event-type probabilities. In block 2702, the trained inference model is used compute run-time estimate KPIs with the event-type probabilities of the even type omitted as described above with reference to Equation (26). In block 2703, compute an MSE to determine degree to which the KPI depends on the event type. In decision block 2704, the operations represented by blocks 2702-2703 are repeated for each even type of the event-type probabilities. In block 2705, a maximum MSE of the MSEs computed in block 2703 is determined. In block 2706, an importance score is computed for each event type based on the MSE of the even type and the maximum MSE. In block 2707, identify event types with the highest ranked importance scores as indications of the root cause.

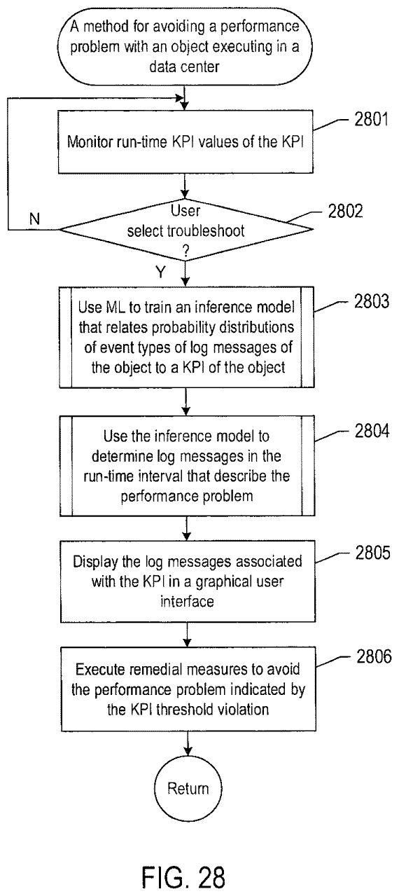

FIG. 28 is a flow diagram illustrating an example implementation of a method for avoiding performance problems with an object executing in a data center. In block 2801, run-time KPI values of the KPI are monitored. The run-time KPI values are displayed in a GUI, such as the GUI 1800 in FIG. 18 or the GUI 2200 in FIG. 22. In decision block 2802, in response to a user selecting to troubleshoot the run-time KPI values via the GUI, control flows to block 2803. In block 2803, the “use machine learning (“MU”) to train an inference model that relates probability distributions of event types of log messages of the object to a KPI of the object” procedure is performed. An example implementation of the “use machine learning (“ML”) to train an inference model that relates probability distributions of event types of log messages of the object to a KPI of the object” process is described above with reference to FIG. 25. In block 2804, the “use the inference model to determine log messages in the run-time interval that describe the performance problem” procedure is performed. An example implementation of the “use the inference model to determine log messages in the run-time interval that describe the performance problem” is described below with reference to FIG. 27. In block 2805, the log messages are displayed in a graphical user interface of an electronic display device as described above with reference to FIGS. 22A-22B. The log messages that are displayed in the GUI describe the event types with importance scores that aid in identifying the impact on the performance of the object. In block 2806, remedial measures to avoid the performance problem associated with the KPI are executed. The remedial measures include, but are not limited to, restarting a host that runs the object, restarting the object, increasing memory or CPU allocation to the object. Other remedial measures include deleting the object and migrating the object to a different host.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method, stored in one or more data-storage devices and executed using one or more processors of a computer system, for resolving a root cause of a performance problem with an object in a data center, the method comprising:
using machine learning to train an inference model that relates probability distributions of event types of log messages of the object to a key performance indicator (“KPI”) of the object;
in response to detecting at least one run-time KPI value that violates a threshold of the KPI, determining probabilities of event types of log messages recorded in a run-time interval;
using the inference model to determine event types of the probabilities of event types of log messages in the run-time interval that describe a root cause of the performance problem; and
executing one or more remedial measures that resolve the root cause of the performance problem, the one or more remedial measures including restarting a host of the object, restarting the object, deleting the object, and migrating the object to a different host.

2. The method of claim 1 wherein using machine learning to train the inference model comprises:
for each KPI, repeat operations comprising:
identifying log messages of a log file with time stamps in a time interval,
extracting event types of the log messages with time stamps in the time interval,
computing event-type probabilities of the extracted event types,
forming a probability distribution from the event-type probabilities; and
form a data frame of the probability distributions and corresponding KPI values.

3. The method of claim 1 wherein using machine learning to train the inference model comprises:
training a parametric inference model based on event-type probabilities and the KPI;
computing a cross-validation estimate of the parametric inference model based on the KPI and a validating set of event-type probabilities and KPI;
using the parametric inference model as the inference model when the cross-validation estimate is less than a cross-validation threshold; and
computing a non-parametric inference model that is used as the inference model when the cross-validation estimate is greater than the cross-validation threshold.

4. The method of claim 1 wherein determining probabilities of event types of log messages recorded in a run-time interval comprises:
identifying log messages of a log file with time stamps in a run-time interval with the KPI value that violates the KPK threshold;
extracting event types of the log messages; and
computing run-time event-type probabilities of the extracted event types.

5. The method of claim 1 wherein using the inference model to determine event types of the probabilities of event types of log messages in the run-time interval that describe a root cause of the performance problem comprises:
for each event type,
computing a run-time estimated KPI based on the inference model and the run-time event-type probabilities with the run-time event-type probabilities omitted. and
computing an error between the run-time estimated KPI and the run-time KPI;
determining a maximum error of the errors computed for each of the errors;
computing an importance score for each of the event types based on the error associated with the even type and the maximum error; and
identifying highest ranked event types based on corresponding importance scores.

6. A computer system for avoiding performance problems with an object executing in a data center, the computer system comprising:
one or more processors;
one or more data-storage devices; and
machine-readable instructions stored in the one or more data-storage devices that when executed using the one or more processors control the system to performance operations comprising:
monitoring run-time values of a key performance indicator (“KPI”) of the object in a graphical user interface (“GUI”);
in response to receiving a command to troubleshoot the object via the, using machine learning to train an inference model that relates probability distributions of event types of log messages of the object to the KPI;
using the inference model to determine event types of the probabilities of event types of log messages in the run-time interval that describe a performance problem; and
executing one or more remedial measures to avoid the performance problem, the one or more remedial measures including restarting a host of the object, restarting the object, deleting the object, and migrating the object to a different host.

7. The system of claim 6 wherein using machine learning to train the inference model comprises:
for each KPI, repeat operations comprising:
identifying log messages of a log file with time stamps in a time interval,
extracting event types of the log messages with time stamps in the time interval,
computing event-type probabilities of the extracted event types,
forming a probability distribution from the event-type probabilities; and
form a data frame of the probability distributions and corresponding KPI values.

8. The system of claim 6 wherein using machine learning to train the inference model comprises:
training a parametric inference model based on event-type probabilities and the KPI;
computing a cross-validation estimate of the parametric inference model based on the KPI and a validating set of event-type probabilities and KPI;
using the parametric inference model as the inference model when the cross-validation estimate is less than a cross-validation threshold; and
computing a non-parametric inference model that is used as the inference model when the cross-validation estimate is greater than the cross-validation threshold.

9. The system of claim 6 wherein determining probabilities of event types of log messages recorded in a run-time interval comprises:
identifying log messages of a log file with time stamps in a run-time interval with the KPI value that violates the KPK threshold;
extracting event types of the log messages: and
computing run-time event-type probabilities of the extracted event types.

10. The system of claim 6 wherein using the inference model to determine event types of the probabilities of event types of log messages in the run-time interval that describe a root cause of the performance problem comprises:
for each event type,
computing a run-time estimated KPI based on the inference model and the run-time event-type probabilities with the run-time event-type probabilities omitted, and
computing an error between the run-time estimated KPI and the run-time KPI;
determining a maximum error of the errors computed for each of the errors;
computing an importance score for each of the event types based on the error associated with the even type and the maximum error; and
identifying highest ranked event types based on corresponding importance scores.

11. A non-transitory computer-readable medium having instructions encoded thereon for enabling one or more processors of a computer system to perform operations comprising:
using machine learning to train an inference model that relates probability distributions of event types of log messages of the object to a key performance indicator (“KPI”) of the object;
in response to detecting at least one run-time KPI value that violates a threshold of the KPI, determining probabilities of event types of log messages recorded in a run-time interval;
using the inference model to determine event types of the probabilities of event types of log messages in the run-time interval that describe a root cause of the performance problem; and
executing one or more remedial measures that resolve the root cause of the performance problem, the one or more remedial measures including restarting a host of the object, restarting the object, deleting the object, and migrating the object to a different host.

12. The medium of claim 11 wherein using machine learning to train the inference model comprises:
for each KPI, repeat operations comprising:
identifying log messages of a log file with time stamps in a time interval,
extracting event types of the log messages with time stamps in the time interval,
computing event-type probabilities of the extracted event types,
forming a probability distribution from the event-type probabilities; and
form a data frame of the probability distributions and corresponding KPI values.

13. The medium of claim 11 wherein using machine learning to train the inference model comprises:
training a parametric inference model based on event-type probabilities and the KPI;
computing a cross-validation estimate of the parametric inference model based on the KPI and a validating set of event-type probabilities and KPI;
using the parametric inference model as the inference model when the cross-validation estimate is less than a cross-validation threshold; and
computing a non-parametric inference model that is used as the inference model when the cross-validation estimate is greater than the cross-validation threshold.

14. The medium of claim 11 wherein determining probabilities of event types of log messages recorded in a run-time interval comprises:
identifying log messages of a log file with time stamps in a run-time interval with the KPI value that violates the KPK threshold;
extracting event types of the log messages; and
computing run-time event-type probabilities of the extracted event types.

15. The medium of claim 11 wherein using the inference model to determine event types of the probabilities of event types of log messages in the run-time interval that describe a root cause of the performance problem comprises:
for each event type,
computing a run-time estimated KPI based on the inference model and the run-time event-type probabilities with the run-time event-type probabilities omitted, and
computing an error between the run-time estimated KPI and the run-time KPI;
determining a maximum error of the errors computed for each of the errors;
computing an importance score for each of the event types based on the error associated with the even type and the maximum error; and
identifying highest ranked event types based on corresponding importance scores.
